(19) United States
(12) Patent Application Publication
(10) Pub. No.: US 2026/0127391 A1
(43) Pub. Date: May 7, 2026

(54) LANGUAGE MODEL BASED RULE DETECTION, IMPROVEMENT, AND APPLICATION MECHANISM

(71) Applicant: Palantir Technologies Inc., Denver, CO (US)

(72) Inventors: Maxime Defauw, Brooklyn, NY (US); Sriram Krishnan, Jersey City, NJ (US)

(21) Appl. No.: 19/209,648

(22) Filed: May 15, 2025

Related U.S. Application Data
(60) Provisional application No. 63/715,062, filed on Nov. 1, 2024.
(60) Provisional application No. 63/729,882, filed on Dec. 9, 2024.

(51) Int. Cl. G06F 40/56; G06F 16/25; G06F 40/103

(52) U.S. Cl. CPC G06F 40/56; G06F 16/258; G06F 40/103

(57) ABSTRACT

The invention relates to a system for developing and designing an AI service, which comprises a task exploration module, a demand analysis module, an AI service construction module and an AI service deployment module; the task exploration module acquires a task background and sends the task background to the demand analysis module after recording; the demand analysis module asks a question to the user according to the initial task description, and updates the initial task description according to the user answer to generate an AI chain frame; the AI service construction module generates a corresponding AI chain based on the AI chain frame and the task background; and the AI service deployment module assembles the working units corresponding to each task step in a serial or parallel mode to form an AI chain, and finally realizes the operation of the AI chain based on each working unit. According to the method and the system, the problem can be solved according to the initial task description, task requirements are more effectively understood, and the AI chain meeting the requirements of clients is generated.

### CROSS-REFERENCE TO RELATED APPLICATIONS

This application claims benefit of U.S. Provisional Patent Application No. 63/715,062, filed Nov. 1, 2024, and titled “LANGUAGE MODEL BASED RULE DETECTION, IMPROVEMENT, AND APPLICATION MECHANISM” and U.S. Provisional Patent Application No. 63/729,882, filed Dec. 9, 2024, and titled “LANGUAGE MODEL-BASED RULE DETECTION, IMPROVEMENT, AND APPLICATION.” The entire disclosures of each of the above items are hereby made part of this specification as if set forth fully herein and incorporated by reference for all purposes, for all that they contain.

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to systems and techniques for utilizing computer-based models. More specifically, various implementations of the present disclosure relate to computerized systems and techniques for using, e.g., large language models to detect, improve, and apply rules.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Computers can be programmed to perform calculations and operations utilizing one or more computer-based models. For example, language models can be utilized to produce text-based outputs based on inputs given to the language models.

### SUMMARY

The systems, methods, and devices described herein each have several aspects, no single one of which is solely responsible for its desirable attributes. Without limiting the scope of this disclosure, several non-limiting features will now be described briefly.

The present disclosure describes various aspects of transforming computer-based information, such as data, from one state to another. A data state can refer to data in a particular state, a particular form, and/or at a particular point in time. Transforming data from an initial data state to a transformed data state can present several technical challenges. For example, data transformations can include transforming a large amount of data together. Further, complex data transformations may require specialized knowledge (also referred to as domain-specific knowledge).

Computer-based models can be used by users to solve various problems. For example, artificial intelligence (“AI”) models, such as language models, large language models (“LLMs”) and/or other AI models, can be useful for data processing, including receiving natural language prompts and providing responses based on data on which the AI model is trained. While other types of AI models may be used in various implementations, for convenience, reference will be made to the use of LLMs in the present disclosure.

LLMs can be used by users to perform various tasks, such as generating, translating, summarizing, and/or otherwise interacting with or processing text based on prompts given to the LLMs. However, using LLMs to perform specialized and repetitive tasks, such as data transformations, may present several technical challenges. For instance, LLMs may generally be trained on broad datasets and may lack the domain-specific knowledge to consistently perform the specialized and repetitive tasks. Further, the output of an LLM may not be determined solely based on an input to the LLM (e.g., the LLM may be nondeterministic). As such, each repetition of a task using an LLM may produce inconsistent results, which may not be desirable for some tasks and may increase the amount of oversight needed to use LLMs for such tasks.

The present disclosure describes systems and methods (generally referred to herein as a “system”) that can, according to various implementations, advantageously overcome various of the technical challenges mentioned above, among other challenges. For example, various implementations of the systems and method of the present disclosure can employ a workflow (including various graphical user interfaces (“GUIs”)) for transforming data from an initial data state to a transformed data state using one or more interactions with LLMs. The system may allow for the generation of one or more transformation rules that can provide structure and/or domain-specific knowledge, increasing the reliability of transformations generated by the LLMs. As will be described in more detail below, the transformation rules may be used by an LLM (e.g., given in prompts to the LLM) along with data in initial states, to transform the data to transformed states in a consistent manner. According to various implementations, the data transformed by the system can include any textual data, such as computer code, documents, metadata, and/or other data represented alphanumerically, and/or other suitable data that can be processed using an LLM or other AI model.

According to various implementations, the system can receive or access one or more data transformations. The data transformations can each include initial data states and corresponding transformed data states. The data transformations can be examples of transformations for a particular task. For example, the data transformations can be examples of transformations from a first code type (e.g., a first coding language or a first coding syntax) to a second code (e.g., a second coding language or a second coding language). In this example, the initial data states can include files of code of the first code type and the transformed data states can include files of code of the second code type that have been transformed from the files of code of the first code type. As another example, the data transformations can be examples of transformations of text in one form to text in another form (e.g., editing the text). In this example, the initial data states can include files of text (e.g., entire documents, one or more strings of text, or other files of text) and the transformed data states can include associated files of transformed text (e.g., with certain words or phrases omitted, edited, or added, or otherwise transformed text). In some implementations, one or more of the data transformations can include user generated (e.g., generated by one or more humans) data transformations. For example, a user may transform one or more initial data states into one or more corresponding transformed data states that are used as examples by the system. In some implementations, one or more of the data transformations can include data transformations previously generated by the system, such as the generated data transformations discussed herein.

The system can generate a first LLM prompt. The first LLM prompt can include one or more of the data transformations discussed above (e.g., as example data transformations). The first LLM prompt can include rule generation instructions. The rule generation instructions can include instructions for the LLM to generate one or more transformation rules based on comparisons between the initial data states and corresponding transformed data states of the included data transformations. The rule generation instructions can also include other information such as format instructions for newly generated transformation rules, instructions on finding similar or duplicate transformation rules, instructions on handling similar or duplicate transformation rules (e.g., instructions to avoid similar or duplicate transformation rules), instructions on finding and/or handling contradictory transformation rules (e.g., instructions to indicate when one transformation rule contradicts another), rules for generating and/or altering confidence scores associated with the transformations, and/or other suitable instructions for LLMs.

The system can provide the first LLM prompt to a first LLM and receive an output (e.g., a first output) from the first LLM in response to the LLM prompt. The system can use the first output to determine one or more transformation rules associated with the data transformations. In some implementations, the system can parse the first output to find the transformation rules. For example, the first LLM prompt can include instructions to output transformation rules in a computer parseable format (e.g., in JavaScript Object Notation (“JSON”)) and the system can parse the first output to find portions of the output that meet the format requirements to determine the transformation rules.

In various implementations, the transformation rules (or indications thereof) can be presented to one or more users (e.g., using the user interfaces described below). The users may review the transformation rules and approve or reject the transformation rules (e.g., via one or more user inputs to the system). Rejected transformation rules may be removed such that the rejected transformation rules are not used in future transformations. In some implementations, rather than accepting or rejecting a transformation rule outright, the users may alter the transformation rule (e.g., via one or more user inputs to the system). For example, a transformation rule may be mostly acceptable to a user and the user may alter the unacceptable portions of the transformation rule.

The system can use the transformation rules to transform new initial data states. For instance, the system can receive or access a first initial data state. The system can generate a second LLM prompt that includes the transformation rules generated (and accepted) above. The second LLM prompt can also include data transformation instructions. The data transformation instructions can include instructions to the LLM to generate a first transformed data state by applying the transformation rules to the first initial data state. In some implementations, the data transformation instructions can include example data transformations that are similar to the first initial data state (similarity may be determined, for example, through a semantic similarity determination). For example, the data transformation instructions can include an example data transformation that a user manually performed on similar initial data states (e.g., from the same source/project and/or from other similar tasks), example data transformations of previously implemented data transformations by the system (e.g., as part of the same overall task), and/or other similar data transformations. Similar initial data states can be determined automatically by the system (e.g., by comparing tasks, by using initial data states from the same source/project) and/or based on user input (e.g., user input selecting a similar initial data state).

The system can provide the second LLM prompt to a second LLM (which may be the same as the first LLM or a different LLM). The second LLM can generate a second output and provide the second output to the system. The system can determine a first transformed data state from the second output.

In some implementations, the system may determine the correctness of the first transformed data state. For example, the system may receive user input accepting, rejecting, and/or altering the first transformed data state or otherwise determine the correctness of the first transformed data state. In some implementations, to determine the correctness of the first transformed data state, the system can parse the first transformed data state, validate the first transformed data state, execute the first transformed data state, otherwise use the first transformed data state, and/or any combination thereof. The system may use the correctness of the first transformed data state to improve subsequent translations (e.g., by updating confidence scores associated with transformation rules used in the second LLM prompt, using the correctness of the first transformation in the rule generation instructions or the data transformation instructions, and/or otherwise using the correctness of the first transformation).

In various implementations, the system may perform a translation of the initial data state more than once. For example, the system, based on the correctness of the transformed data state, may determine to perform the translation of the initial data state again. various some implementations, the system may incorporate feedback into re-running the second LLM prompt when reperforming a translation of the initial data state. The feedback may be determined automatically. By automatically determining whether previous transformations are correct and incorporating feedback into the generation of future transformation rules, the system may achieve iterative improvements in transformation rule accuracy in order to achieve automatic data transformation that are more efficient and more accurate than data transformations achieved using known methods. For example, the feedback can include a log of a failed execution of the first transformed data state. The feedback may be manually entered by a user (e.g., using the user interface described below).

While the above describes the use of the system to transform a single initial data state (the first initial data state), it can be appreciated, the systems and methods described herein may be used to transform multiple initial data states simultaneously and/or in batches. Further, information (e.g., data transformation, transformation rules, confidence scores, and/or other information) from previously transformed batches of initial data states can be used in subsequent transformations (e.g., as feedback into the first and second LLM prompt), which may provide further context to the LLM, improve the consistency of the transformations, and/or reduce the amount of human intervention needed.

In some implementations, the system may generate a confidence score associated with each transformation rule. The confidence score can provide further context to the transformation rules. The system may use the confidence score when choosing which transformation rules to use for a given data transformation. For example, the system may only use transformation rules above a threshold value for a given data transformation.

In various implementations, the rule generation instructions in the first LLM prompt include instructions to the LLM to create an associated confidence score with each generated transformation rule. The confidence score may be based on how confident the first LLM is that the transformation rule is correct and/or applicable to other transformations. In some implementations, the confidence score is input by a user (e.g., using the user interface described below).

In some implementations, the system can automatically update a confidence score of a transformation rule based on other transformation rules. For example, the system may determine a different transformation rule contradicts the transformation rule and decrease the confidence score of the transformation rule. In another example, the system may determine a subsequent transformation rule is similar or a duplicate to a transformation rule and increase the confidence score of the transformation rule.

In some implementations, the system can update a confidence score of a transformation rule based on user input. For example, a user input accepting the transformation rule can increase the confidence score of that transformation rule. In another example, a user editing a transformed data state associated with a transformation rule can decrease the confidence score of that transformation rule. Similarly, in another example, a user accepting a transformed data state associated with a transformation rule can increase the confidence score of that transformation rule.

The system may further allow one or more users to interact with the system through user interfaces (e.g., GUIs or other types of user interfaces), and receive user requests for performing tasks. Users may use the user interfaces to create and/or input example data transformations that are used by the system (e.g., in generating the first LLM prompt or the second LLM prompt). For example, the user may take initial data states and create associated transformed data states and input both into the system to be used to generate the transformation rules (e.g., in the first LLM prompt).

The transformation rules (or indications thereof) can be presented the users through the user interfaces. The users may review the transformation rules and approve or reject the transformation rules (e.g., via one or more user inputs to the system). Rejected transformation rules may be removed such that the rejected transformation rules are not used in future transformations (e.g., the rejected transformation rules are not used in the second LLM prompt). In some implementations, rather than accepting or rejecting a transformation rule outright, the users may alter the transformation rule (e.g., via one or more user inputs to the system). For example, a transformation rule may be mostly acceptable to a user and the user may alter the unacceptable portions of the transformation rule.

According to various implementations, initial data states (or indications thereof) can be presented the users through the user interfaces. For example, an indication of the first initial data state can be generated and/or caused to display on a GUI. Transformed data states (or indications thereof) can be presented the users through the user interfaces. For example, an indication of the first transformed data state can be generated and/or caused to display on a GUI. Transformed data states may be displayed next to the corresponding initial data states. The users may alter the transformed data states output by the system (e.g., the first transformed data state). For example, the first transformed data state may include some errors. In this example, a user may enter changes to the first transformed data state to correct the errors. In some implementations, when a user alters a transformed data state, one or more transformation rules associated with the transformed data state may be flagged, updated, and/or removed. In some implementations, when a user alters a transformed data state, the confidence scores of the transformation rules associated with the transformed data state may be altered (e.g., decreased). Similarly, when a user approves a transformed data state, and/or otherwise does not modify the transformed data state, the confidence scores of the transformations rules associated with the transformed data state may be, e.g., increased. Transformations rules associated with transformed data states may comprise any rules that were used by the system (e.g., including the LLM) to generate the transformed data state. In some implementations, the user input (e.g., the alterations to the transformed data state) may be used (e.g., as feedback or examples) in future iterations of the first and second LLM prompts. In some examples, the system may automatically gather feedback on the validity of previously generated transformations rules by automatically executing generated data transformation rules and keeping a log of data transformation rules that fail to execute correctly. Automatically gathered feedback can be provided to future iterations of the first and second LLM prompts to achieve automatic improvements to the transformation rules.

In some implementations, the user interface may include a listing of the created transformation rules. The user may select a transformation rule from the listing to accept, reject, or edit the transformation rule. In some implementations, a user may select a transformation rule from the listing and view indications of any other similar transformation rule (or the similar transformation rules themselves) and/or indications of any transformation rules that contradict the selected transformation rule. Similarity between transformation rules may be determined automatically. For example, the rule generation instructions may include instructions for the LLM to compare semantic similarity or other similarities of determined transformation rules to transformation rules already in the system. In some implementations, a user interface may display confidence scores associated with each transformation rule.

Thus, various implementations of the present disclosure can provide improvements to various technologies and technological fields, and practical applications of various technological features and advancements. For example, as described above, existing techniques of data transformation may involve transforming a large amount of data together and require specialized knowledge, and various implementations of this disclosure provide significant technical improvements over such technology. Additionally, various implementations of the present disclosure are inextricably tied to computer technology. In particular, various implementations rely on operation of technical computer systems and electronic data stores, automatic processing of electronic data, and the like. Such features and others (e.g., receiving or accessing data transformations, generating and displaying a user interface including transformation rules, receiving user input to user interfaces, and/or other features described herein) are intimately tied to, and enabled by, computer technology, and would not exist except for computer technology. For example, the interactions with, and management of, AI models described below in reference to various implementations cannot reasonably be performed by humans alone, without the computer technology upon which they are implemented. Further, the implementation of the various implementations of the present disclosure via computer technology enables many of the advantages described herein, including more efficient management of various types of electronic data (including computer-based models).

Various combinations of the above and below recited features, embodiments, implementations, and aspects are also disclosed and contemplated by the present disclosure.

Additional implementations of the disclosure are described below in reference to the appended claims, which may serve as an additional summary of the disclosure.

In various implementations, systems and/or computer systems are disclosed that comprise one or more computer-readable storage mediums or devices comprising, configured to store, and/or storing program instructions, and one or more processors configured to execute the program instructions to cause the systems and/or computer systems to perform operations comprising one or more aspects of the above- and/or below-described implementations (including one or more aspects of the appended claims).

In various implementations, computer-implemented methods are disclosed in which, by one or more processors executing program instructions, one or more aspects of the above- and/or below-described implementations (including one or more aspects of the appended claims) are implemented and/or performed.

In various implementations, computer program products comprising one or more computer-readable storage mediums or devices, and/or one or more computer-readable storage mediums or devices, are disclosed, wherein the computer-readable storage mediums comprise, are configured to store, and/or store program instructions, the program instructions executable by one or more processors to cause the one or more processors to perform operations comprising one or more aspects of the above- and/or below-described implementations (including one or more aspects of the appended claims).

### BRIEF DESCRIPTION OF THE DRAWINGS

The following drawings and the associated descriptions are provided to illustrate implementations of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 is a block diagram illustrating an example data transformation system in an example computing environment, according to various implementations of the present disclosure;

FIG. 2 is a block diagram illustrating example aspects of a transformation rule, according to various implementations;

FIG. 3A is a flowchart illustrating an example method of generating a transformation rule, according to various implementations;

FIG. 3B is a flowchart illustrating an example method of translating data states, according to various implementations;

FIG. 4 is an example interactive graphical user interface associated with the data transformation system, according to various implementations;

FIG. 5 is another example interactive graphical user interface associated with the data transformation system, according to various implementations;

FIGS. 6A and 6B show additional example interactive graphical user interfaces associated with the data transformation system, according to various implementations; and

FIG. 7 is a block diagram of an example computer system consistent with various implementations of the present disclosure.

### DETAILED DESCRIPTION

Although certain preferred implementations, embodiments, and examples are disclosed below, the inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

### Overview

The present disclosure describes various aspects of transforming computer-based information, such as data, from one state to another. A data state can refer to data in a particular state, a particular form, and/or at a particular point in time. Transforming data from an initial data state to a transformed data state can present several technical challenges. For example, data transformations can include transforming a large amount of data together. Further, complex data transformations may require specialized knowledge (also referred to as domain-specific knowledge).

Computer-based models can be used by users to solve various problems. For example, artificial intelligence (“AI”) models, such as language models, large language models (“LLMs”) and/or other AI models, can be useful for data processing, including receiving natural language prompts and providing responses based on data on which the AI model is trained. While other types of AI models may be used in various implementations, for convenience, reference will be made to the use of LLMs in the present disclosure.

LLMs can be used by users to perform various tasks, such as generating, translating, summarizing, and/or otherwise interacting with or processing text based on prompts given to the LLMs. However, using LLMs to perform specialized and repetitive tasks, such as data transformations, may present several technical challenges. For instance, LLMs may generally be trained on broad datasets and may lack the domain-specific knowledge to consistently perform the specialized and repetitive tasks. Further, the output of an LLM may not be determined solely based on an input to the LLM (e.g., the LLM may be nondeterministic). As such, each repetition of a task using an LLM may produce inconsistent results, which may not be desirable for some tasks and may increase the amount of oversight needed to use LLMs for such tasks.

The present disclosure describes systems and methods (generally referred to herein as a “system”) that can, according to various implementations, advantageously overcome various of the technical challenges mentioned above, among other challenges. For example, various implementations of the systems and method of the present disclosure can employ a workflow (including various graphical user interfaces (“GUIs”)) for transforming data from an initial data state to a transformed data state using one or more interactions with LLMs. The system may allow for the generation of one or more transformation rules that can provide structure and/or domain-specific knowledge, increasing the reliability of transformations generated by the LLMs. As will be described in more detail below, the transformation rules may be used by an LLM (e.g., given in prompts to the LLM) along with data in initial states, to transform the data to transformed states in a consistent manner. According to various implementations, the data transformed by the system can include any textual data, such as computer code, documents, metadata, and/or other data represented alphanumerically, and/or other suitable data that can be processed using an LLM or other AI model.

According to various implementations, the system can receive or access one or more data transformations. The data transformations can each include initial data states and corresponding transformed data states. The data transformations can be examples of transformations for a particular task. For example, the data transformations can be examples of transformations from a first code type (e.g., a first coding language or a first coding syntax) to a second code (e.g., a second coding language or a second coding language). In this example, the initial data states can include files of code of the first code type and the transformed data states can include files of code of the second code type that have been transformed from the files of code of the first code type. As another example, the data transformations can be examples of transformations of text in one form to text in another form (e.g., editing the text). In this example, the initial data states can include files of text (e.g., entire documents, one or more strings of text, or other files of text) and the transformed data states can include associated files of transformed text (e.g., with certain words or phrases omitted, edited, or added, or otherwise transformed text). In some implementations, one or more of the data transformations can include user generated (e.g., generated by one or more humans) data transformations. For example, a user may transform one or more initial data states into one or more corresponding transformed data states that are used as examples by the system. In some implementations, one or more of the data transformations can include data transformations previously generated by the system, such as the generated data transformations discussed herein.

The system can generate a first LLM prompt. The first LLM prompt can include one or more of the data transformations discussed above (e.g., as example data transformations). The first LLM prompt can include rule generation instructions. The rule generation instructions can include instructions for the LLM to generate one or more transformation rules based on comparisons between the initial data states and corresponding transformed data states of the included data transformations. The rule generation instructions can also include other information such as format instructions for newly generated transformation rules, instructions on finding similar or duplicate transformation rules, instructions on handling similar or duplicate transformation rules (e.g., instructions to avoid similar or duplicate transformation rules), instructions on finding and/or handling contradictory transformation rules (e.g., instructions to indicate when one transformation rule contradicts another), rules for generating and/or altering confidence scores associated with the transformations, and/or other suitable instructions for LLMs.

The system can provide the first LLM prompt to a first LLM and receive an output (e.g., a first output) from the first LLM in response to the LLM prompt. The system can use the first output to determine one or more transformation rules associated with the data transformations. In some implementations, the system can parse the first output to find the transformation rules. For example, the first LLM prompt can include instructions to output transformation rules in a computer parseable format (e.g., in JavaScript Object Notation (“JSON”)) and the system can parse the first output to find portions of the output that meet the format requirements to determine the transformation rules.

In various implementations, the transformation rules (or indications thereof) can be presented to one or more users (e.g., using the user interfaces described below). The users may review the transformation rules and approve or reject the transformation rules (e.g., via one or more user inputs to the system). Rejected transformation rules may be removed such that the rejected transformation rules are not used in future transformations. In some implementations, rather than accepting or rejecting a transformation rule outright, the users may alter the transformation rule (e.g., via one or more user inputs to the system). For example, a transformation rule may be mostly acceptable to a user and the user may alter the unacceptable portions of the transformation rule.

The system can use the transformation rules to transform new initial data states. For instance, the system can receive or access a first initial data state. The system can generate a second LLM prompt that includes the transformation rules generated (and accepted) above. The second LLM prompt can also include data transformation instructions. The data transformation instructions can include instructions to the LLM to generate a first transformed data state by applying the transformation rules to the first initial data state. In some implementations, the data transformation instructions can include example data transformations that are similar to the first initial data state (similarity may be determined, for example, through a semantic similarity determination). For example, the data transformation instructions can include an example data transformation that a user manually performed on similar initial data states (e.g., from the same source/project and/or from other similar tasks), example data transformations of previously implemented data transformations by the system (e.g., as part of the same overall task), and/or other similar data transformations. Similar initial data states can be determined automatically by the system (e.g., by comparing tasks, by using initial data states from the same source/project) and/or based on user input (e.g., user input selecting a similar initial data state).

The system can provide the second LLM prompt to a second LLM (which may be the same as the first LLM or a different LLM). The second LLM can generate a second output and provide the second output to the system. The system can determine a first transformed data state from the second output.

In some implementations, the system may determine the correctness of the first transformed data state. For example, the system may receive user input accepting, rejecting, and/or altering the first transformed data state or otherwise determine the correctness of the first transformed data state. In some implementations, to determine the correctness of the first transformed data state, the system can parse the first transformed data state, validate the first transformed data state, execute the first transformed data state, otherwise use the first transformed data state, and/or any combination thereof. The system may use the correctness of the first transformed data state to improve subsequent translations (e.g., by updating confidence scores associated with transformation rules used in the second LLM prompt, using the correctness of the first transformation in the rule generation instructions or the data transformation instructions, and/or otherwise using the correctness of the first transformation).

In various implementations, the system may perform a translation of the initial data state more than once. For example, the system, based on the correctness of the transformed data state, may determine to perform the translation of the initial data state again. In some implementations, the system may incorporate feedback into the second LLM prompt when reperforming a translation of the initial data state. The feedback may be determined automatically. For example, the feedback can include a log of a failed execution of the first transformed data state. The feedback may be manually entered by a user (e.g., using the user interface described below).

While the above describes the use of the system to transform a single initial data state (the first initial data state), it can be appreciated, the systems and methods described herein may be used to transform multiple initial data states simultaneously and/or in batches. Further, information (e.g., data transformation, transformation rules, confidence scores, and/or other information) from previously transformed batches of initial data states can be used in subsequent transformations (e.g., as feedback into the first and second LLM prompt), which may provide further context to the LLM, improve the consistency of the transformations, and/or reduce the amount of human intervention needed.

### Example Features Related to Confidence Scores

In some implementations, the system may generate a confidence score associated with each transformation rule. The confidence score can provide further context to the transformation rules. The system may use the confidence score when choosing which transformation rules to use for a given data transformation. For example, the system may only use transformation rules above a threshold value for a given data transformation.

In various implementations, the rule generation instructions in the first LLM prompt include instructions to the LLM to create an associated confidence score with each generated transformation rule. The confidence score may be based on how confident the first LLM is that the transformation rule is correct and/or applicable to other transformations. In some implementations, the confidence score is input by a user (e.g., using the user interface described below).

In some implementations, the system can automatically update a confidence score of a transformation rule based on other transformation rules. For example, the system may determine a different transformation rule contradicts the transformation rule and decrease the confidence score of the transformation rule. In another example, the system may determine a subsequent transformation rule is similar or a duplicate to a transformation rule and increase the confidence score of the transformation rule.

In some implementations, the system can update a confidence score of a transformation rule based on user input. For example, a user input accepting the transformation rule can increase the confidence score of that transformation rule. In another example, a user editing a transformed data state associated with a transformation rule can decrease the confidence score of that transformation rule. Similarly, in another example, a user accepting a transformed data state associated with a transformation rule can increase the confidence score of that transformation rule.

### Example Features Related to User Interfaces

The system may further allow one or more users to interact with the system through user interfaces (e.g., GUIs or other types of user interfaces), and receive user requests for performing tasks. Users may use the user interfaces to create and/or input example data transformations that are used by the system (e.g., in generating the first LLM prompt or the second LLM prompt). For example, the user may take initial data states and create associated transformed data states and input both into the system to be used to generate the transformation rules (e.g., in the first LLM prompt).

The transformation rules (or indications thereof) can be presented the users through the user interfaces. The users may review the transformation rules and approve or reject the transformation rules (e.g., via one or more user inputs to the system). Rejected transformation rules may be removed such that the rejected transformation rules are not used in future transformations (e.g., the rejected transformation rules are not used in the second LLM prompt). In some implementations, rather than accepting or rejecting a transformation rule outright, the users may alter the transformation rule (e.g., via one or more user inputs to the system). For example, a transformation rule may be mostly acceptable to a user and the user may alter the unacceptable portions of the transformation rule.

According to various implementations, initial data states (or indications thereof) can be presented the users through the user interfaces. For example, an indication of the first initial data state can be generated and/or caused to display on a GUI. Transformed data states (or indications thereof) can be presented the users through the user interfaces. For example, an indication of the first transformed data state can be generated and/or caused to display on a GUI. Transformed data states may be displayed next to the corresponding initial data states. The users may alter the transformed data states output by the system (e.g., the first transformed data state). For example, the first transformed data state may include some errors. In this example, a user may enter changes to the first transformed data state to correct the errors. In some implementations, when a user alters a transformed data state, one or more transformation rules associated with the transformed data state may be flagged, updated, and/or removed. In some implementations, when a user alters a transformed data state, the confidence scores of the transformation rules associated with the transformed data state may be altered (e.g., decreased). Similarly, when a user approves a transformed data state, and/or otherwise does not modify the transformed data state, the confidence scores of the transformations rules associated with the transformed data state may be, e.g., increased. Transformations rules associated with transformed data states may comprise any rules that were used by the system (e.g., including the LLM) to generate the transformed data state. In some implementations, the user input (e.g., the alterations to the transformed data state) may be used (e.g., as feedback or examples) in future iterations of the first and second LLM prompts.

In some implementations, the user interface may include a listing of the created transformation rules. The user may select a transformation rule from the listing to accept, reject, or edit the transformation rule. In some implementations, a user may select a transformation rule from the listing and view indications of any other similar transformation rule (or the similar transformation rules themselves) and/or indications of any transformation rules that contradict the selected transformation rule. Similarity between transformation rules may be determined automatically. For example, the rule generation instructions may include instructions for the LLM to compare semantic similarity or other similarities of determined transformation rules to transformation rules already in the system. In some implementations, a user interface may display confidence scores associated with each transformation rule.

### Example Implementations of the System

LLMs can be helpful for a variety of tasks. However, LLMs generally do not contain domain knowledge for a specific and repeated task. Disclosed herein is an approach which allows for an AI model, such as an LLM, to automatically extract knowledge through rules (also referred to herein as transformation rules or insights) using prior examples, reinforce those rules over time, and apply these rules to perform the task on new information.

The disclosed approach, according to various implementations, uses one or more LLMs to parse through past examples of a task to perform to generate transformation rules. According to various implementations, the approach can include a workflow to accept, reject, or edit transformation rules (e.g., using a graphical user interface (“GUI”) to present the transformation rules to a user and receive user input to accept, reject, and/or edit the transformation rules). In various implementations, the approach can include a process to increase and/or decrease a confidence score of a transformation rule using additional examples, or to flag contradictions. The confidence score can be used (e.g., by a user, by the LLM, and/or otherwise used) when applying the transformation rule to new information.

In various implementations, the disclosed approach may use a workflow to apply the extracted knowledge (e.g., using the transformation rules) to new information. In various implementations, the results of the application of a transformation rule to new information may be attached to a workflow that can provide a feedback loop to transformation rules and alter the transformation rule and/or a confidence score of the transformation rule. For example, a user may accept the transformation rule in the workflow and increase a confidence score of the transformation rule.

This workflow can allow for automatically extracting knowledge from prior examples of a transformation task (e.g., an example of a translation from one form to another, an example of text editing, an example rule detection, and/or another transformation task) that can then be reinforced over time and applied on new examples. An initial step for the workflow can include detecting transformation rules from current examples. This initial step can include prompting an LLM to go over pairs of transformation (input and output) and detect and/or extract insights or learnings about that transformation (e.g., transformation rules).

The prompt to the LLM can include previous insights and learnings. The previous insight and learnings can help to avoid duplicating learnings when producing new insights. The previous insights and learning can also help allow for confirmation and/or contradiction detection of previously created insights. An example of such a prompt is shown below.

In various implementation, if a newly determined transformation rule corresponds to a previously detected transformation rule, the confidence score of that the newly determined transformation rule and/or the previously detected transformation rule can increase. If a newly determined transformation rule contradicts a previously detected transformation rule, that contradiction can be flagged and/or the confidence of the newly determined transformation rule and/or the previously detected transformation rule can decrease.

In various implementations, the workflow can include presenting transformation rules to a to a user with domain knowledge. That user can then approve the transformation rules, increasing the confidence score of the transformation rules. Alternatively, the user can disapprove the transformation rules, decreasing the confidence score of the transformation rules. In various implementations, the user can otherwise edit the transformation rules.

The transformation rules can be used to perform a new transformation. To do so, the transformation rules can be used in a prompt to an LLM along with input data of new and never before seen example. The transformation rules can provide context to the input data that is used to perform the new transformation. The prompt can include persona information, a task to perform (e.g., transform the input), and the use of the transformation rules to give the LLM domain level knowledge that the LLM would otherwise not poses (e.g., syntax rules of the input and/or output).

In various implementations, the workflow can include recording and presenting to a user any newly transformed examples that used one or more transformation rules, along with the proposed application of an transformation rule that produced the transformation. A user can then approve, disapprove, and/or add more context, which would in turn increase or decrease a confidence score of the transformation rule or edit the transformation rule.

For illustration, a few example applications of the workflow are provided below. In a first example, the workflow is used in code translation. In the example, the workflow is used to migrate code from a first code segment using one dialect to a second code segment using a second dialect. When performed manually, such migration could take as long as 3 years. However, using the workflow described above the time to migrate the can be reduced. While LLMs are used in these examples, other AI models may be used in some implementations.

In a first step of the first example, previous code translations (original code, and translated code) are provided along with a prompt to the LLM instructing the LLM to look for insights or general rules for the of translations (e.g., transformations rules) using the techniques described above. Each code translation can be used multiple times to extract additional insights or general rules. The following is an example first prompt to an LLM for the first step of the first example:
You are an expert responsible for analyzing translations of type_1 code to type_2 code, and finding patterns or general insights that could be considered a rule for these types of translations/
Take into account previously discovered rules and insights, so that one does not create duplicate insights. This means that a new insight is only new if it is not already (partly) covered.
Make sure the insights are generalized. There is no need to talk about a specific table individually.

~~~~~~~~~~~~~~~~~~~~~~~~~~~~~~~~~~~~~~~~~~~~~~~~~~~~~~~~~~
~~~~
Take into account the following previously identified and hence not to duplicate
insights: {insights}.
Check for new insights using the following translations of multiple type_1 code
segments to type_2 code segments:
The names of the translated type_1 code segments are:
[CONCATENATED_TYPE_1_CODE_SEGMENTS_NAMES]
The content of the type_1 code segments are:
[CONCATENATED_TYPE_1_CODE_SEGMENTS_CONTENTS]
The content of the type_2 code segments are:
[CONCATENATED_TYPE_2_CODE_SEGMENTS_CONTENTS]
~~~~~~~~~~~~~~~~~~~~~~~~~~~~~~~~~~~~~~~~~~~~~~~~~~~~~~~~~~
~~~~
For every insight detected, respond using the following fields:
* is_new_insight: a true / false value to identify if this is a novel insight that is
not present in the previously identified insights
* is_contradiction: a true / false value to identify whether this newly detected
insight is a contradiction to previous insights, or if one of the previous insights
is not entirely correct based on this example
* insight: a string explaining the insight found
* confidence_score: a score between 0 and 1 based on how strong the
confidence of this insight is
The output needs to be an array of insights in JSON format.
Example: \\[
\\{{″is_new_insight″: true, ″is_contradiction″: false, ″insight″: ″Add a ‘config‘
block at the beginning of the type_2 code segments to define code segment
attributes if necessary.″, ″confidence_score″: 0.6}}\\,
\\{{″is_new_insight″: false, ″is_contradiction″: true, ″insight″: ″Current
insights suggest that a first syntax was used for a loop, whereas here we use the
first syntax to define intermediate steps and common table expressions (CTEs)
for better readability and modularity″, ″confidence_score″: 0.7}}\\]
″″″
# Example: {{[{″is_new_insight″: true, ″is_contradiction″: false, ″insight″:
″Add a ‘config‘ block at the beginning of the type_2 code segments to define
code segment attributes if necessary.″},
# ″is_new_insight″: false, ″is_contradiction″: true, ″insight″: ″Current insights
suggest that a first syntax was used for a loop, whereas here we use the first
syntax to define intermediate steps and common table expressions (CTEs) for
better readability and modularity″}]}}
#

Some of the text of the text of the example prompt above may be a placeholder for text that is inserted by the system before the prompt is sent to the LLM. For example, the system can insert a list of names each type_1 code segment used in place of “[CONCATENATED_TYPE_1_CODE_SEGMENTS_NAMES],” the content of the type_1 code segments in place of “[CONCATENATED_TYPE_1_CODE_SEGMENTS_NAMES],” and the content of the content of the type_2 code segments in place of “[CONCATENATED_TYPE_2_CODE_SEGMENTS_CONTENTS].”

In a next step of the first example, the insights are presented to an experienced user, such as one who has created and/or inspected similar translations. In the first example, the insights (e.g. 40 insights) may be presented and inspected. Some of the insights presented (e.g., 30 insights) may be directly approved (e.g., approved without any edits), while others (e.g., 5 insights) may be approved after minor edits. Some insights may be rejected by the user and not used in future translations. In various implementations, some insights may be manually added (e.g., defined by a user rather than the LLM). In the first example, when the user approves the insight, the confidence score of the insight would not automatically increase. However, in some implementations, a user approving, disapproving, and/or editing an insight may automatically alter the confidence score of the insight (e.g., approving the insight may automatically increase the confidence score of the insight and disapproving the insight may automatically decrease the confidence score of the insight). The following are a few examples of insights an LLM may generate and present to a user:
1) Include metadata columns such as metadata_inserted_timestamp and metadata_updated_timestamp to track the insertion and update times of records.
2) Use select*except (column1, column2) to exclude specific columns from the final output.
3) Use if conditions within type_2 code segments to handle incremental loads and full loads differently.

In a further step of the first example, previously untranslated code (e.g., initial data states of the first example) is given in a second prompt to the LLM with the instructions to translate the untranslated code (e.g., into translated data states of the first example), along with all approved insights detected as described above. In various implementations, the prompt can also include example translations of similar code. The LLM then outputs the translated code. The following is an example prompt to an LLM for this further step of the first example:
You are an expert in writing type_2 code segments. Your job is to accurately convert one type_1 code segment to one or more valid type_2 code segments.
A type_1 code segment will have a name and contents. They can be translated into one or more than one type_2 code segments.
To help with this, there are a couple of things you can use:
   Translation Feedbacks: first and foremost, when translating consider and take into account user provided feedback on a PREVIOUS translation of this type_1 code segment to type_2 code segments. PRIORITIZE previously translated content and feedback.
   Rules: secondly, consider the following general rules to help you understand how to convert the incoming type_1 code segments Content into the Translated type 2 content.
   Previous Translations: thirdly, use these DIFFERENT previous translations as examples. They are to be used to help translate the incoming code segments content.
For EVERY new type_2 code segment created, use the CREATE_TRANSLATION_FEEDBACK tool to save the translation. If you need to translate into two type_2 code segments, use the tool TWICE, and SEPARATELY. This means that you should iteratively use the CREATE_TRANSLATION_FEEDBACK tool but NOT mention its name twice in a single call.
   Type_1 Code Segment Name=the incoming type_1 code segment name.
   Translated Code Segment Name=the incoming type_1 code segment name adjusted for type_2. If you only output 1 generated code segment to translation feedback action, add ‘_v1’ as a suffix when passing the type_1 code segment name to the action. If you output 2 generated code segments to translation feedback, add ‘_v2’ as a suffix.
   Translated Code Segment Content=the output that you are tasked to generate.
Arguments must be provided in the form: <argumentName1>: <argument Value1><argumentName2>: <argument Value2> . . . -Where <argumentName> must be one of [type_1Code_segmentsName1, translatedCode_segmentsName1, translatedCode_segmentsContent1, token]-<argument Value> MUST be on a single line, if you require a multi-line value, use ‘\n’ to denote a newline
[TRANSLATION FEEDBACK, IF APPLICABLE]
[LISTING OF TRANSLATION RULES]
[EXAMPLES OF SIMILAR PREVIOUS TRANSLATIONS]
[CODE SEGMENT(S) TO BE TRANSLATED]

Some of the text of the text of the example prompt above may be a placeholder for text that is inserted by the system before the prompt is sent to the LLM. For example, the system can insert feedback (e.g., feedback from a previous translation) in place of “[TRANSLATION FEEDBACK, IF APPLICABLE],” a listing of each translation rule in place of “[LISTING OF TRANSLATION RULES],” examples of similar previous translations in place of “[EXAMPLES OF SIMILAR PREVIOUS TRANSLATIONS],” and/or the code segments in place of “[CODE SEGMENT(S) TO BE TRANSLATED].” Further, some of the example operations described in the example prompt above may be optional. For example, some examples of the prompt may not have feedback to incorporate. In some implementations, optional language may be omitted from the prompt.

In a second example, the workflow is used to edit (e.g., redline) text documents (e.g. contracts). In the second example, the changes to the document are small additions, scraping or replacing of words, or removals, and/or other edits. In a first step of the second example, previously redlined contracts are presented in a prompt (e.g. as input and output) to an LLM and the LLM detects one or more rules. In a next step, these rules are presented to a user (e.g., a subject matter expert) and approved, rejected, or edited by the use.

In a next step of the second example, a new contract (or portion of a contract) is presented in a prompt to the LLM along with the determined and approved rules that apply to the new contract (or portion of the contract). The LLM then outputs one or more “redline suggestions” that 1) show the proposed change and 2) tie back to the original insight that produced that suggestion.

In a further step of the second example, a user (e.g., a subject matter expert) reviews the redline suggestions (e.g., by approving or disapproving each suggestion) for the given contract (or portion of the contract). In various implementations the user can see the changes implemented live in the contract. In the second example, whenever a suggestion is approved or rejected, the confidence score of the insight can be adjusted. Likewise, if a user changes or edits a redline suggestion, the insight that generated the redline suggestion can be altered. Hence, insights can improve over time by repeated uses (and alterations) of the insight in previous workflows.

In a third example, the workflow can be used to automatically detect rules for employee expense policies. In this example, a corpus of metadata about expenses and whether or not those expenses were approved is presented in a prompt to an LLM. The LLM is tasked with finding insights based on the metadata and whether or not those expenses were approved. These insights may be presented to a user to confirm or reject the insights. The insights may be used in a prompt to an LLM with new metadata of employee expenses to determine recommended expense approvals or denials.

In various implementations, the system may automatically confirm or reject the insights over time. At first, the LLM may come up with hypothesis rules for a few expenses and expense metadata that it looks at, in a first batch. For a next batch of expenses, these rules are then evaluated to see if they apply to the expenses in the batch. If the rules apply to the expenses in the batch, the confidence score of the rule increases. If the rule does not apply to the expenses in the batch, the confidence score of the rule decreases. The LLM can also hypothesize new rules for the expenses and expense metadata in the batch and add them to the rules to be used in future batches. As the LLM uses the list of hypothesis rules on more and more batches of expenses, confidence scores associated with the rules can be automatically updated, reenforcing the applicable rules. In this way rules are produced that effectively capture domain knowledge about the employee expense policies.

### Further Example Information Related to Various Implementations

To facilitate an understanding of the systems and methods discussed herein, several terms are described below and herein. These terms, as well as other terms used herein, should be construed to include the provided descriptions, the ordinary and customary meanings of the terms, and/or any other implied meaning for the respective terms, wherein such construction is consistent with context of the term. Thus, the descriptions below and herein do not limit the meaning of these terms, but only provide example descriptions.

The term “model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like. A “nondeterministic model” as used in the present disclosure, is any model in which the output of the model is not determined solely based on an input to the model. Examples of nondeterministic models include language models such as LLMs, ML models, and the like. In general, the term “AI model,” as used herein, may refer to any ML model, NN, language model, and/or the like.

A Language Model is any algorithm, rule, model, and/or other programmatic instructions that can predict the probability of a sequence of words. A language model may, given a starting text string (e.g., one or more words), predict the next word in the sequence. A language model may calculate the probability of different word combinations based on the patterns learned during training (based on a set of text data from books, articles, websites, audio files, etc.). A language model may generate many combinations of one or more next words (and/or sentences) that are coherent and contextually relevant. Thus, a language model can be an advanced artificial intelligence algorithm that has been trained to understand, generate, and manipulate language. A language model can be useful for natural language processing, including receiving natural language prompts and providing natural language responses based on the text on which the model is trained. A language model may include an n-gram, exponential, positional, neural network, and/or other type of model.

A Large Language Model (“LLM”) is any type of language model that has been trained on a larger data set and has a larger number of training parameters compared to a regular language model. An LLM can understand more intricate patterns and generate text that is more coherent and contextually relevant due to its extensive training. Thus, an LLM may perform well on a wide range of topics and tasks. An LLM may comprise a NN trained using self-supervised learning. An LLM may be of any type, including a Question Answer (“QA”) LLM that may be optimized for generating answers from a context, a multimodal LLM/model, and/or the like. An LLM (and/or other models of the present disclosure), may include, for example, attention-based and/or transformer architecture or functionality. LLMs can be useful for natural language processing, including receiving natural language prompts and providing natural language responses based on the text on which the model is trained. LLMs may not be data security- or data permissions-aware, however, because they generally do not retain permissions information associated with the text upon which they are trained. Thus, responses provided by LLMs are typically not limited to any particular permissions-based portion of the model.

While certain aspects and implementations are discussed herein with reference to use of a language model, LLM, AI, and/or AI model, those aspects and implementations may be performed by any other language model, LLM, AI model, generative AI model, generative model, ML model, NN, multimodal model, and/or other algorithmic processes. Similarly, while certain aspects and implementations are discussed herein with reference to use of a ML model, language model, or LLM, those aspects and implementations may be performed by any other AI model, generative AI model, generative model, NN, multimodal model, and/or other algorithmic processes.

In various implementations, the LLMs and/or other models (including AI models and/or ML models) of the present disclosure may be locally hosted, cloud managed, accessed via one or more Application Programming Interfaces (“APIs”), and/or any combination of the foregoing and/or the like. Additionally, in various implementations, the LLMs and/or other models (including AI models and/or ML models) of the present disclosure may be implemented in or by electronic hardware such application-specific processors (e.g., application-specific integrated circuits (“ASICs”)), programmable processors (e.g., field programmable gate arrays (“FPGAs”)), application-specific circuitry, and/or the like. Data that may be queried using the systems and methods of the present disclosure may include any type of electronic data, such as text, files, documents, books, manuals, emails, images, audio, video, databases, metadata, positional data (e.g., geo-coordinates), geospatial data, sensor data, web pages, time series data, and/or any combination of the foregoing and/or the like. In various implementations, such data may comprise model inputs and/or outputs, model training data, modeled data, and/or the like.

Examples of models, language models, and/or LLMs that may be used in various implementations of the present disclosure include, for example, Bidirectional Encoder Representations from Transformers (BERT), LaMDA (Language Model for Dialogue Applications), PaLM (Pathways Language Model), PaLM 2 (Pathways Language Model 2), Generative Pre-trained Transformer 2 (GPT-2), GPT-3, GPT-4, GPT-40, LLAMA (Large Language Model Meta AI), and BigScience Large Open-science Open-access Multilingual Language Model (BLOOM).

A Prompt (or “Natural Language Prompt” or “Model Input”) can be, for example, a term, phrase, question, and/or statement written in a human language (e.g., English, Chinese, Spanish, and/or the like), and/or other text string, that may serve as a starting point for a language model and/or other language processing. A prompt may include only a user input or may be generated based on a user input, such as by a prompt generation module (e.g., of a document search system) that supplements a user input with instructions, examples, and/or information that may improve the effectiveness (e.g., accuracy and/or relevance) of an output from the language model. A prompt may be provided to an LLM which the LLM can use to generate a response (or “model output”).

A User Operation (or “User Input”) can be any operations performed by one or more users to user interface(s) and/or other user input devices associated with a system (e.g., the data extraction system). User operation can include a request for task(s) to be performed, such as by using a machine learning model and/or an LLM, in whole or in part. User operation can include a request for data, such as data accessed and/or processed by one or more services. User operation can include one or more queries, one or more questions, one or more requests, or the like. User operation may include one or more natural language instructions for some data analysis (e.g., prediction, estimation, classification, or the like) to be performed. User operations can include, for example, select, drag, move, group, or the like, one or more interactive graphical representations for updating an ontology.

### Example System and Related Computing Environment

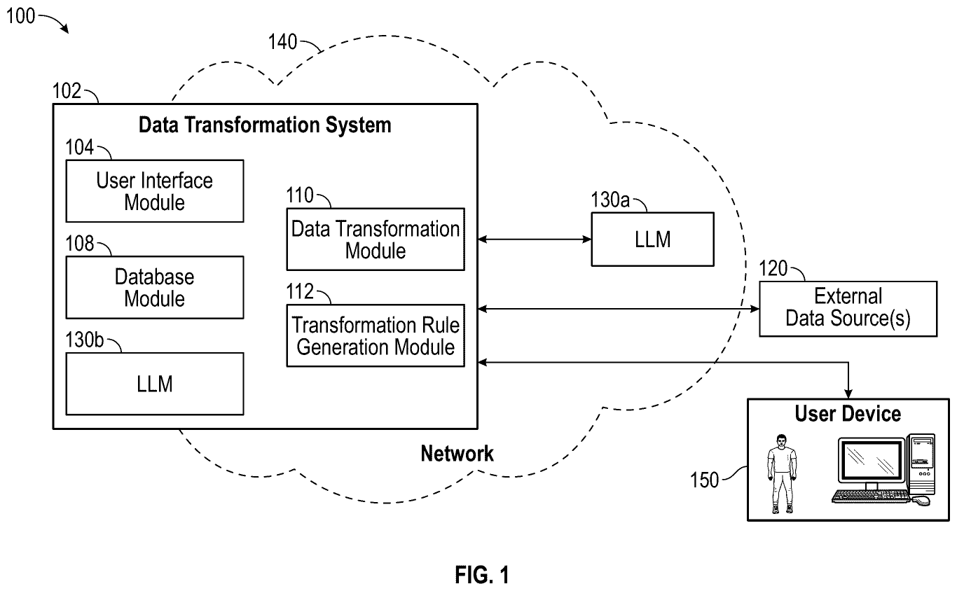

FIG. 1 illustrates an example computing environment 100 including an example data transformation system 102 in communication with various devices, according to various implementations of the present disclosure. The example computing environment 100 includes the data transformation system 102, one or more LLMs (e.g., LLM 130a), a network 140, one or more external data sources 120, and a user device 150 (and/or user computing device). In the example of FIG. 1, the data transformation system 102 comprises various modules, including a user interface module 104, a data transformation module 110, a transformation rule generation module 112, a database module 108, and one or more LLMs (e.g., LLM 130b). In other embodiments, the data transformation system 102 may include fewer or additional components.

In the example of FIG. 1, the various devices are in communication via a network 140, which may include any combination of networks, such as one or more local area network (LAN), personal area network (PAN), wide area network (WAN), Global System for Mobile Communications (GSM) network, a Code Division Multiple Access (CDMA) network, a Long Term Evolution (LTE) network, the Internet, and/or any other communication network. The network 140 can use protocols and components for communicating via the Internet or any of the other aforementioned types of networks. For example, the protocols used by the network 140 may include Hypertext Transfer Protocol (HTTP), HTTP Secure (HTTPS), Message Queue Telemetry Transport (MQTT), Constrained Application Protocol (CoAP), and the like. In various implementations, modules of the illustrated components, such as the user interface module 104, the database module 108, the data transformation module 110, and the transformation rule generation module 112 of the data transformation system 102, may communicate via an internal bus and/or via the network 140. Additionally, the data transformation system 102 may communicate with the one or more LLMs (e.g., the LLM 130a), the user devices 150, and the external data sources 120 via the network 140 in the course of fulfilling an objective and/or a user input.

The database module 108 and or the external data sources 120 may be configured to store data that may be accessed by the user device 150 and/or various aspects of the data transformation system 102, as described herein. For example, the database module 108 is configured to store data/information that may be utilized by the data transformation module 110 and the transformation rule generation module, and/or accessed or manipulated by the user device 150. The database module 108 of the data transformation system 102 may obtain and store data and/or information from the external data sources 120. Data that may be stored by the database module 108 and/or the external data sources 120 may include any type of electronic data, such as error logs, code files, documents, text, data files, books, manuals, emails, images, audio, video, databases, metadata, positional data (e.g., geo-coordinates), sensor data, web pages, time series data, and/or any combination of the foregoing and/or the like. The database module 108 and/or the external data sources 120 may store the data using an ontology which may define data types and associated properties, and relationships among data types, properties, and/or the like. The ontology may constitute a way to represent things in the world. The ontology may be used by an organization to model a view on what objects exist in the world, what their properties are, and how they are related to each other. The ontology may be user-defined, computer-defined, or some combination of the two. The ontology may include hierarchical relationships among data object types.

As shown in FIG. 1, the data transformation system 102 may be capable of interfacing with multiple LLMs. This allows for experimentation, hot-swapping and/or adaptation to different models based on specific use cases or requirements, providing versatility and scalability to the system. In various implementations, the data transformation system 102 may interface with the LLM 130b and/or the LLM 130a in order to, for example, determine transformation rules, determine transformed data states, generate or alter confidences scores, determine correctness of transformed data states, generate feedback, and/or perform other functionality described herein. Although FIG. 1 illustrates that the LLM 130a is internal to the data transformation system 102 and the LLM 130b is external to the data transformation system 102, in various implementations the LLM 130a and/or the LLM 130b can be internal or external to the data transformation system 102.

The transformation rule generation module 112 may generate and/or manage transformation rules. As described above, transformation rule generation module 112 can receive or access one or more data transformations (e.g., from the database module 108 and/or the external data sources 120). The data transformations can each include initial data states and corresponding transformed data states. The data transformations can be examples of transformations for a particular task. For example, the data transformations can be examples of transformations from a first code type (e.g., a first coding language or a first coding syntax) to a second code (e.g., a second coding language or a second coding language). In this example, the initial data states can include files of code of the first code type and the transformed data states can include files of code of the second code type that have been transformed from the files of code of the first code type. As another example, the data transformations can be examples of transformations of text in one form to text in another form (e.g., editing the text). In this example, the initial data states can include files of text (e.g., entire documents, one or more strings of text, or other files of text) and the transformed data states can include associated files of transformed text (e.g., with certain words or phrases omitted, edited, or added, or otherwise transformed text). In some implementations, one or more of the data transformations can include user generated (e.g., generated by one or more humans via the user device 150) data transformations. For example, a user may transform one or more initial data states into one or more corresponding transformed data states that are used as examples by the transformation rule generation module 112. In some implementations, one or more of the data transformations can include data transformations previously generated by the transformation rule generation module 112, such as the generated data transformations discussed herein.

The transformation rule generation module 112 can generate a first LLM prompt. The first LLM prompt can include one or more of the data transformations discussed above (e.g., as example data transformations). The first LLM prompt can include rule generation instructions. The rule generation instructions can include instructions for the LLM to generate one or more transformation rules based on comparisons between the initial data states and corresponding transformed data states of the included data transformations. The rule generation instructions can also include other information such as format instructions for newly generated transformation rules, instructions on finding similar or duplicate transformation rules, instructions on handling similar or duplicate transformation rules (e.g., instructions to avoid similar or duplicate transformation rules), instructions on finding and/or handling contradictory transformation rules (e.g., instructions to indicate when one transformation rule contradicts another), rules for generating and/or altering confidence scores associated with the transformations, and/or other suitable instructions for LLMs.

The transformation rule generation module 112 can provide the first LLM prompt to a first LLM (e.g., the LLM 130a or the LLM 130b) and receive an output (e.g., a first output) from the first LLM in response to the LLM prompt. The transformation rule generation module 112 can use the first output to determine one or more transformation rules associated with the data transformations. In some implementations, the transformation rule generation module 112 can parse the first output to find the transformation rules. For example, the first LLM prompt can include instructions to output transformation rules in a computer parseable format (e.g., in JavaScript Object Notation (“JSON”)) and the transformation rule generation module 112 can parse the first output to find portions of the output that meet the format requirements to determine the transformation rules. The transformation rules (and any associated confidence scores) may be stored on the database module 108 and/or the external data sources 120 and accessed by other components of the data transformation system 102 (e.g., the data transformation module 110) and or the computing environment 100 (e.g., the user device 150).

In various implementations, the transformation rules (or indications thereof) can be presented to one or more users (e.g., to the user device 150 using the user interfaces described below). The users may review the transformation rules and approve or reject the transformation rules (e.g., via one or more user inputs to the user device 150). Rejected transformation rules may be removed such that the rejected transformation rules are not used in future transformations. In some implementations, rather than accepting or rejecting a transformation rule outright, the users may alter the transformation rule (e.g., via one or more user inputs to the user device 150). For example, a transformation rule may be mostly acceptable to a user and the user may alter the unacceptable portions of the transformation rule.

In some implementations, the transformation rule generation module 112 may generate a confidence score associated with each transformation rule. The confidence score can provide further context to the transformation rules. As described below, the data transformation module 110 may use the confidence score when choosing which transformation rules to use for a given data transformation. For example, the data transformation module 110 may only use transformation rules above a threshold value for a given data transformation.

In various implementations, the rule generation instructions in the first LLM prompt include instructions to the LLM to create an associated confidence score with each generated transformation rule. The confidence score may be based on how confident the first LLM is that the transformation rule is correct and/or applicable to other transformations. In some implementations, the confidence score is input by a user (e.g., via a user device 150 and one or more user interfaces described below).

In some implementations, the transformation rule generation module 112 can automatically update a confidence score of a transformation rule based on other transformation rules. For example, the transformation rule generation module 112 may determine a different transformation rule contradicts the transformation rule and decrease the confidence score of the transformation rule. In another example, the transformation rule generation module 112 may determine a subsequent transformation rule is similar or a duplicate to a transformation rule and increase the confidence score of the transformation rule.

In some implementations, the transformation rule generation module 112 can update a confidence score of a transformation rule based on user input. For example, a user input accepting the transformation rule can increase the confidence score of that transformation rule. In another example, a user editing a transformed data state associated with a transformation rule can decrease the confidence score of that transformation rule. Similarly, in another example, a user accepting a transformed data state associated with a transformation rule can increase the confidence score of that transformation rule.

The data transformation module 110 can use the transformation rules to transform new initial data states. For instance, the data transformation module 110 can receive or access a first initial data state (e.g., from the database module 108 and/or the external data sources 120). The data transformation module 110 can generate a second LLM prompt that includes the transformation rules generated by the transformation rule generation module 112. In some implementations, the data transformation module 110 (and/or a user) can select the transformation rules for the second LLM prompt. In some implementations, the computing environment 100 may automatically select transformation rule for the second LLM prompt (e.g., using confidence scores, a determined similarity, and/or another criteria).

The second LLM prompt can also include data transformation instructions. The data transformation instructions can include instructions to the LLM to generate a first transformed data state by applying the transformation rules to the first initial data state. In some implementations, the data transformation instructions can include example data transformations that are similar to the first initial data state (similarity may be determined, for example, through a semantic similarity determination). For example, the data transformation instructions can include an example data transformation that a user manually performed on similar initial data states (e.g., from the same source/project and/or from other similar tasks), example data transformations of previously implemented data transformations by the system (e.g., as part of the same overall task), and/or other similar data transformations. Similar initial data states can be determined automatically by the data transformation module 110 (e.g., by comparing tasks, by using initial data states from the same source/project) and/or based on user input (e.g., user input selecting a similar initial data state).

The data transformation module 110 can provide the second LLM prompt to a second LLM (e.g., the LLM 130a or LLM 130b), which may be the same as the first LLM or a different LLM. The second LLM can generate a second output and provide the second output to the data transformation module 110. The data transformation module 110 can determine a first transformed data state from the second output.

In some implementations, the data transformation module 110 may determine the correctness of the first transformed data state. For example, the data transformation module 110 may receive user input (e.g., from the user device 150) accepting, rejecting, and/or altering the first transformed data state or otherwise determine the correctness of the first transformed data state. In some implementations, to determine the correctness of the first transformed data state, the data transformation module 110 (and/or another component of the data transformation system 102 and/or the computing environment 100) can parse the first transformed data state, validate the first transformed data state, execute the first transformed data state, otherwise use the first transformed data state, and/or any combination thereof. The data transformation module 110 may use the correctness of the first transformed data state to improve subsequent translations (e.g., by updating confidence scores associated with transformation rules used in the second LLM prompt, using the correctness of the first transformation in the rule generation instructions or the data transformation instructions, and/or otherwise using the correctness of the first transformation).

In various implementations, the data transformation module 110 may perform a translation of the initial data state more than once. For example, the data transformation module 110, based on the correctness of the transformed data state, may determine to perform the translation of the initial data state again. In some implementations, the data transformation module 110 may incorporate feedback into the second LLM prompt when reperforming a translation of the initial data state. The feedback may be determined automatically. For example, the feedback can include a log of a failed execution of the first transformed data state. The feedback may be manually entered by a user (e.g., using the user interface described below).

While the above describes the use of the data transformation module 110 and/or transformation rule generation module 112 to transform a single initial data state (the first initial data state), it can be appreciated, the systems and methods described herein may be used to transform multiple initial data states simultaneously and/or in batches. Further, information (e.g., data transformation, transformation rules, confidence scores, and/or other information) from previously transformed batches of initial data states can be used in subsequent transformations (e.g., as feedback into the first and second LLM prompt), which may provide further context to the LLM, improve the consistency of the transformations, and/or reduce the amount of human intervention needed.

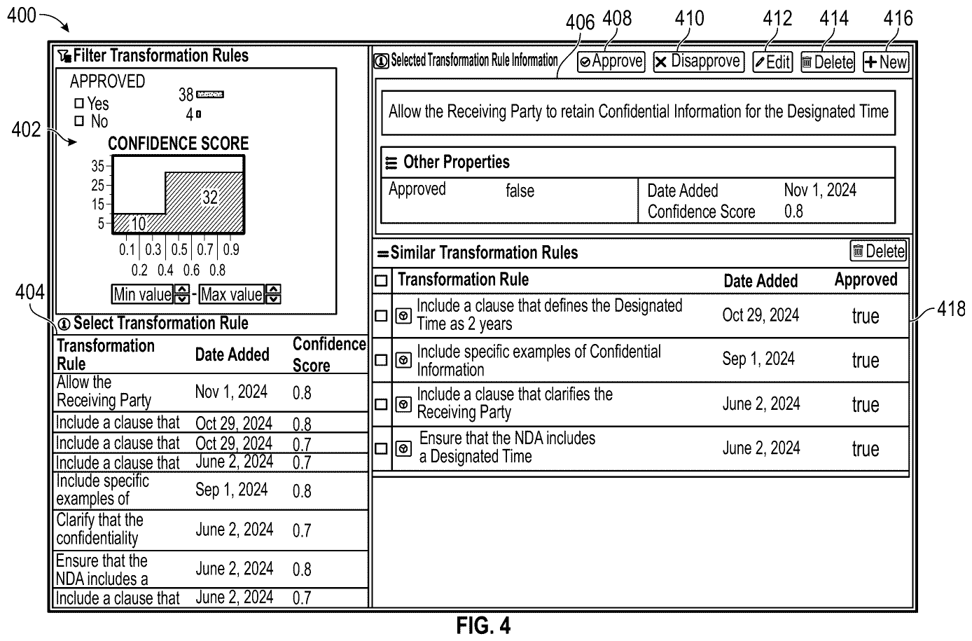

The user interface module 104 is configured to generate user interface data that may be rendered on a user device 150, such as to receive an initial user input, as well as later user input that may be used to initiate further data processing. In various implementations, the functionality discussed with reference to the user interface module 104, and/or any other user interface functionality discussed herein, may be performed by a device or service outside of the data transformation system 102 and/or the user interface module 104 may be outside the data transformation system 102. Example user interfaces are described in greater detail below with reference to FIGS. 4, 5, 6A and 6B.

Users may use (e.g., via a user device 150) the user interfaces to create and/or input example data transformations that are used by the data transformation system 102 (e.g., in generating the first LLM prompt or the second LLM prompt). For example, the user may take initial data states and create associated transformed data states and input both into the system to be used to generate the transformation rules (e.g., in the first LLM prompt).

The transformation rules (or indications thereof) can be presented the users through the user interfaces. The users may review the transformation rules and approve or reject the transformation rules (e.g., via one or more user inputs to a user device 150). In some implementations, rather than accepting or rejecting a transformation rule outright, the users may alter the transformation rule (e.g., via one or more user inputs to a user device 150). For example, a transformation rule may be mostly acceptable to a user and the user may alter the unacceptable portions of the transformation rule.

According to various implementations, initial data states (or indications thereof) can be presented the users through the user interfaces. For example, an indication of the first initial data state can be generated and/or caused to display on a GUI. Transformed data states (or indications thereof) can be presented the users through the user interfaces. For example, an indication of the first transformed data state can be generated and/or caused to display on a GUI. Transformed data states may be displayed next to the corresponding initial data states. The users may alter the transformed data states output by the system (e.g., the first transformed data state). For example, the first transformed data state may include some errors. In this example, a user may enter changes to the first transformed data state to correct the errors. In some implementations, when a user alters a transformed data state, one or more transformation rules associated with the transformed data state may be flagged, updated, and/or removed. In some implementations, when a user alters a transformed data state, the confidence scores of the transformation rules associated with the transformed data state may be altered (e.g., decreased). Similarly, when a user approves a transformed data state, and/or otherwise does not modify the transformed data state, the confidence scores of the transformations rules associated with the transformed data state may be, e.g., increased. Transformations rules associated with transformed data states may comprise any rules that were used by the system (e.g., including the LLM) to generate the transformed data state. In some implementations, the user input (e.g., the alterations to the transformed data state) may be used (e.g., as feedback or examples) in future iterations of the first and second LLM prompts.

In some implementations, the user interface may include a listing of the created transformation rules. The user may select a transformation rule from the listing to accept, reject, or edit the transformation rule. In some implementations, a user may select a transformation rule from the listing and view indications of any other similar transformation rule (or the similar transformation rules themselves) and/or indications of any transformation rules that contradict the selected transformation rule. Similarity between transformation rules may be determined automatically. For example, the rule generation instructions may include instructions for the LLM to compare semantic similarity or other similarities of determined transformation rules to transformation rules already in the system. In some implementations, a user interface may display confidence scores associated with each transformation rule.

### Example System and Related Modules

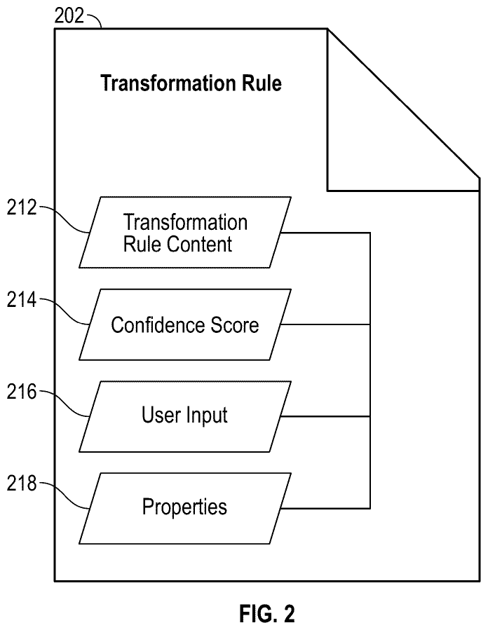

FIG. 2 is a block diagram illustrating example aspects of a transformation rule 202 (e.g., as generated and/or used by the data transformation system 102), according to various implementations. In the illustrated example the transformation rule 202 includes transformation rule content 212, a confidence score 214, user input 216, and properties 218. As illustrated in FIG. 2, the various components of a transformation rule 202 may be connected and changes to any component may impact one or more aspects of the other components.

The transformation rule content 212 can be contents of the transformation rule. In some implementations, the transformation rule content 212 can be a text string providing instructions (e.g., rules) for transforming data. As described above, the transformation rule content 212 can be placed in an LLM prompt along with data transformation instructions that include instructions to generate a transformed data state by applying the transformation rule content 212 to an initial data state. The following are a few examples of transformation rule contents 212:
Example 1: “Include metadata columns such as metadata_inserted_timestamp and metadata_updated_timestamp to track the insertion and update times of records.”
Example 2: “Use select*except (column1, column2) to exclude specific columns from the final output.”
Example 3: “Use if conditions within type_2 code segments to handle incremental loads and full loads differently.”
Example 4: “Allow the Receiving Party to retain Confidential Information for the Designated Time”
Example 5: “Ensure that the NDA includes a Designated Time”

The confidence score 214 may be a value indicative of a confidence that the transformation rule 202 is correct and/or applicable to other data transformations. The confidence score 214 may be generated by an LLM. For example, the confidence score may be based on how confident the LLM is that the transformation rule is correct and/or applicable to other transformations. In some implementations, the confidence score is input by a user (e.g., using the user interface described below).

The confidence score 214 can provide further context to the transformation rules. The data transformation system 102 (and/or a user accessing the data transformation system 102) may use the confidence score 214 when choosing which transformation rules 202 to use for a given data transformation. For example, the data transformation system 102 may only use transformation rules above a threshold value for a given data transformation.

In some implementations, the data transformation system 102 can automatically update a confidence score 214 of a transformation rule 202 based on other transformation rules. For example, the data transformation system 102 may determine a different transformation rule contradicts the transformation rule 202 and decrease the confidence score 214 of the transformation rule 202. In another example, the data transformation system 102 may determine a subsequent transformation rule is similar or a duplicate to a transformation rule 202 and increase the confidence score 214 of the transformation rule 202.

In some implementations, the data transformation system 102 can update a confidence score 214 of a transformation rule confidence score 214 based on user input 216. For example, a user input 216 accepting the transformation rule 202 can increase the confidence score 214 of that transformation rule 202. In another example, a user editing a transformed data state associated with a transformation rule 202 can decrease the confidence score 214 of that transformation rule 202. Similarly, in another example, a user accepting a transformed data state associated with a transformation rule 202 can increase the confidence score 214 of that transformation rule 202.

The user input 216 can be one or more inputs (e.g., using user device 150) associated with the transformation rule 202. The user input 216 can include inputs affecting the confidence score 214, as described above, inputs accepting or rejecting the transformation rule 202, inputs changing the transformation rule content 212, and/or inputs to one or more aspects associated with the transformation rule 202 (e.g., through metadata in the properties 218), such as inputs accepting, rejecting, or editing a transformed data state associated with the transformation rule 202. The user input 216 may change and/or update one or more other aspects of the transformation rule 202. For example, user input may alter the transformation rule content 212, the confidence score 214, and/or properties 218 of the transformation rule 202.

The properties 218 can include additional data and/or metadata associated with the transformation rule 202. For example, the properties 218 can include an indication if the transformation rule has been approved, an indication of a date added, information regarding initial and transformed data states used to generate the transformation rule 202, initial and transformed data states used in association with the transformation rule 202, and/or other properties described herein.

### Example Functionality and Operations of the System

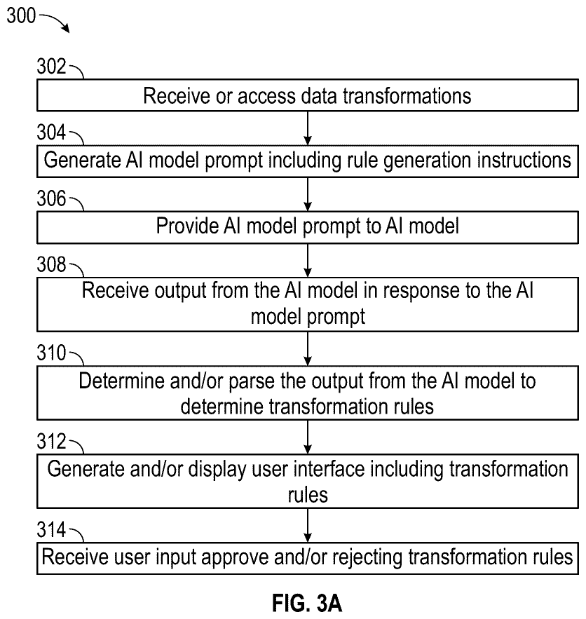

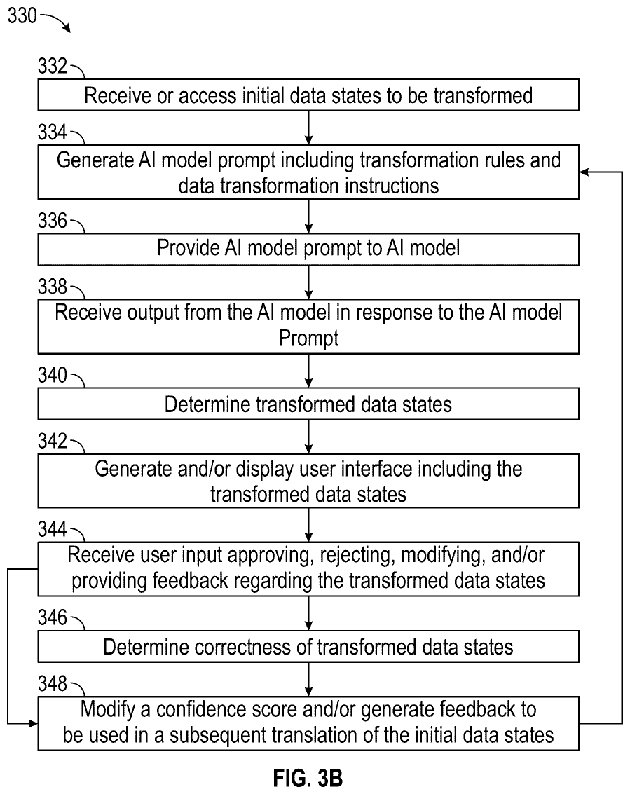

FIGS. 3A and 3B show flowcharts illustrating example operations of the data transformation system 102 (and/or various other aspects of the example computing environment 100), according to various embodiments. The blocks of the flowcharts illustrate example implementations, and in various other implementations various blocks may be rearranged, optional, and/or omitted, and/or additional block may be added. In various embodiments, the example operations of the system illustrated in FIGS. 3A and 3B may be implemented, for example, by the one or more aspects of the data transformation system 102, various other aspects of the example computing environment 100, and/or the like.

FIG. 3A depicts a flowchart illustrating an example method 300 according to various embodiments. The method 300 may be implemented, for example, by the data transformation system 102 of FIG. 1 to generate a transformation rule using one or more AI models (e.g., LLM 130a, 130b).

At block 302, the data transformation system 102 receives or accesses data transformations. For example, the data transformation system 102 may access data transformations stored in the database module 108 and/or the external data sources 120. In some implementations, the data transformations may be selected by a user (e.g., using a user device 150). The data transformations can each include one or more initial data states and respective corresponding transformed data states.

As described above, the data transformations can be examples of transformations for a particular task. For example, the data transformations can be examples of transformations from a first code type (e.g., a first coding language or a first coding syntax) to a second code (e.g., a second coding language or a second coding language). In this example, the initial data states can include files of code of the first code type and the transformed data states can include files of code of the second code type that have been transformed from the files of code of the first code type. As another example, the data transformations can be examples of transformations of text in one form to text in another form (e.g., editing the text). In this example, the initial data states can include files of text (e.g., entire documents, one or more strings of text, or other files of text) and the transformed data states can include associated files of transformed text (e.g., with certain words or phrases omitted, edited, or added, or otherwise transformed text). In some implementations, one or more of the data transformations can include user generated (e.g., generated by one or more humans) data transformations. For example, a user may transform one or more initial data states into one or more corresponding transformed data states that are used as examples by the system. In some implementations, one or more of the data transformations can include data transformations previously generated by the system, such as the generated data transformations discussed herein.

At block 304, the data transformation system 102 generates an AI model prompt (e.g., a first LLM prompt). The AI model prompt can include one or more of the data transformations discussed above (e.g., as example data transformations). The AI model prompt can include rule generation instructions. The rule generation instructions can include instructions for the AI model to generate one or more transformation rules based on comparisons between the initial data states and corresponding transformed data states of the included data transformations. The rule generation instructions can also include other information such as format instructions for newly generated transformation rules, instructions on finding similar or duplicate transformation rules, instructions on handling similar or duplicate transformation rules (e.g., instructions to avoid similar or duplicate transformation rules), instructions on finding and/or handling contradictory transformation rules (e.g., instructions to indicate when one transformation rule contradicts another), rules for generating and/or altering confidence scores associated with the transformations, and/or other suitable instructions for AI models.

At block 306, the data transformation system 102 provides the AI model prompt to an AI model (e.g., LLM 130a or LLM 130b). For example, the data transformation system 102 can provide the AI model prompt to an AI model in the data transformation system 102 (e.g., LLM 130b) and/or provide the AI model prompt to an AI model outside the data transformation system 102 (e.g., LLM 130a) using the network 140.

At block 308, the data transformation system 102 receives output (e.g., a first output) from the AI model in response to the AI model prompt. For example, the data transformation system 102 can receive the output from an AI model in the data transformation system 102 (e.g., LLM 130b) and/or from an AI model outside the data transformation system 102 (e.g., LLM 130a) using the network 140.

At block 310, the data transformation system 102 determines and/or parses the output from the AI model to determine one or more transformation rules (e.g., transformation rules 202). For example, in some implementations the AI model prompt can include instructions to output transformation rules in a computer parseable format (e.g., in JavaScript Object Notation (“JSON”)) and the data transformation system 102 can parse the output to find portions of the output that meet the format requirements to determine the transformation rules. In some implementations, the system may determine and/or parse the output from the AI model to determine confidence scores associated with the transformation rule (e.g., confidence scores 214).

As described above, the confidence scores may be values indicative of a confidence that the transformation rule is correct and/or applicable to other data transformations. The confidence score may be generated by an the AI model. For example, the confidence score may be based on how confident the AI model is that the transformation rule is correct and/or applicable to other transformations. In some implementations, the confidence score is input by a user (e.g., using the user interface described below). The confidence score can provide further context to the transformation rules and may be used by the data transformation system 102 when using the associated transformation rules (e.g., in method 330 described below).

At block 312, the data transformation system 102 may generate and/or display one or more user interfaces that include the transformation rules. For example, the user interface module 104 may generate user interface 400, described below with reference to FIG. 4, and/or a different user interface. The user interface may be presented to a user (e.g., using user device 150).

At block 314, the data transformation system 102 may receive user input (e.g., from the user device 150) approving or rejecting one or more of the transformation rules. For example, users may review the transformation rules displayed at block 312 and approve or reject the transformation rules. Rejected transformation rules may be removed such that the rejected transformation rules are not used in future transformations. In some implementations, rather than accepting or rejecting a transformation rule outright, the users may alter the transformation rule (e.g., via one or more user inputs to the system). For example, a transformation rule may be mostly acceptable to a user and the user may alter the unacceptable portions of the transformation rule. In some implementations, when a user accepts a transformation rule, a confidence score associated with that transformation rule is increased, and when a user rejects a transformation rule the confidence score associated with the transformation rule is decreased.

FIG. 3B depicts a flowchart illustrating an example method 330 according to various embodiments. The method 330 may be implemented, for example, by the data transformation system 102 of FIG. 1 transform initial data states using one or more AI models (e.g., LLM 130a, 130b).

At block 332, the data transformation system 102 receives or accesses one or more initial data states to be transformed. For example, the data transformation system 102 may access initial data states stored in the database module 108 and/or the external data sources 120. In some implementations, the initial data states may be selected by a user (e.g., using a user device 150). The initial data states may be data that is to be transformed by the data transformation system 102. The initial data states can include data in any form. For example, the initial data can be information of a first code type and/or syntax, text in a first form, metadata, and/or other appropriate forms of data for the data transformation system 102 to transform.

At block 334, the data transformation system 102 generates an AI model prompt including one or more transformation rules and data transformation instructions. The transformation rules can be previously generated by the data transformation system 102 (e.g., using method 300). The data transformation instructions can include instructions to an AI model (e.g., LLM 130a, 130b) to generate one or more transformed data states by applying the transformation rules to the initial data state received or accessed at block 332. In some implementations, the data transformation instructions can include example data transformations that are similar to the initial data states (similarity may be determined, for example, through a semantic similarity determination). For example, the data transformation instructions can include an example data transformation that a user manually performed on similar initial data states (e.g., from the same source/project and/or from other similar tasks), example data transformations of previously implemented data transformations by the system (e.g., as part of the same overall task), and/or other similar data transformations. Similar initial data states can be determined automatically by the system (e.g., by comparing tasks, by using initial data states from the same source/project) and/or based on user input (e.g., user input selecting a similar initial data state).

At block 336, the data transformation system 102 provides the AI model prompt to an AI model. For example, the data transformation system 102 can provide the AI model prompt to an AI model in the data transformation system 102 (e.g., LLM 130b) and/or provide the AI model prompt to an AI model outside the data transformation system 102 (e.g., LLM 130a) using the network 140. In some implementations, the AI model is the same AI model used at block 306 of method 300.

At block 338, the data transformation system 102 receives output (e.g., a second output) from the AI model in response to the AI model prompt. For example, the data transformation system 102 can receive the output from an AI model in the data transformation system 102 (e.g., LLM 130b) and/or from an AI model outside the data transformation system 102 (e.g., LLM 130a) using the network 140.

At block 340, the data transformation system 102 determines one or more transformed data states from the AI model output. In some implementations, the entire AI model output may correspond to one or more transformed data states. In some implementations, the data transformation system 102 can extract one or more transformed data states from the AI model output (e.g., by parsing the AI model output).

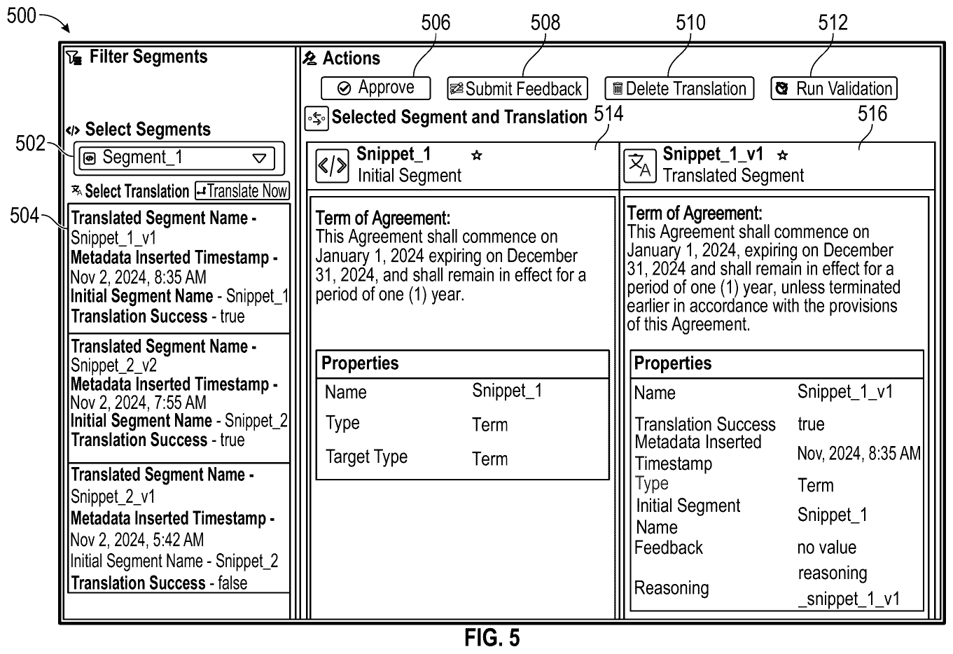

At block 342, the data transformation system 102, may generate and/or display one or more user interfaces that include the transformed data states. For example, the user interface module 104 may generate user interface 400, described below with reference to FIG. 5, and/or a different user interface The user interface may be presented to a user (e.g., using user device 150). The user interface can include a presentation of an initial data state and a corresponding transformed data state.

At block 344, the data transformation system 102 may receive user input approving, rejecting modifying, and/or providing feedback regarding the transformed data states. For example, a user may review the information in the user interface displayed at block 342 and approve or reject the transformed data states. Rejected transformed data states may be transformed again by the data transformation system 102 (e.g., by reentering the initial data state associated with the rejected transformed data state into an AI model prompt at block 334). The user input can include feedback associated with the transformed data state. The feedback may be used in subsequent data transformations performed by the data transformation system 102. For example, the feedback may be used in the data transformation instructions of the AI model prompt generated at block 334.

In some implementations, users may modify the transformed data states output by the data transformation system 102. For example, the transformed data states may include some errors. In this example, a user may enter changes to the transformed data state to correct the errors. In some implementations, when a user alters a transformed data state, one or more transformation rules associated with the transformed data state may be flagged, updated, and/or removed.

At block 346, the data transformation system 102 determines a correctness of the transformed data states. For example, the data transformation system 102 may receive user input accepting, rejecting, and/or altering the transformed data states (e.g., input from block 344) or otherwise determine the correctness of the transformed data states. In some implementations, to determine the correctness of the transformed data states, the data transformation system 102 can parse the transformed data states, validate the transformed data states, execute the transformed data states, otherwise use the transformed data states, and/or any combination thereof. The data transformation system 102 may use the correctness of transformed data states to improve subsequent translations (e.g., by updating confidence scores associated with transformation rules used in the second LLM prompt, using the correctness of the transformation in the rule generation instructions or the data transformation instructions, and/or otherwise using the correctness of the transformation).

At block 348, the data transformation system 102 modifies a confidence score and/or generates feedback to be used in subsequent translations of initial data states. The modifications to the confidence scores and/or feedback may be user generated. In some implementations, when a user alters a transformed data state, the confidence scores of the transformation rules associated with the transformed data state may be altered (e.g., decreased). Similarly, when a user approves a transformed data state, and/or otherwise does not modify the transformed data state, the confidence scores of the transformations rules associated with the transformed data state may be, e.g., increased. Transformations rules associated with transformed data states may comprise any rules that were used by the system (e.g., including the AI model) to generate the transformed data state. In some implementations, the user input (e.g., the alterations to the transformed data state) may be used (e.g., as feedback or examples) in future iterations of the AI model prompt. The user generated feedback can be a written description associated with the transformed data state (e.g., “this should have been X, instead of Y”).

In some implementations, the modifications to the confidence scores and/or feedback may be automatically generated by the data transformation system 102 without user feedback. For example, the data transformation system 102 may use information associated with the correctness determination at block 346 (e.g., error logs from a failed execution of a transformed data state) as feedback. The data transformation system 102 can automatically adjust a confidence score of one or more transformation rules based on a determination that a transformed data state is incorrect.

In some implementations, all, or a portion, of method 330 may be reperformed. For example, blocks 334 to 348 may be reperformed for an initial data state based on a determination that a transformed data state was incorrect (e.g., at block 346), based on user feedback (e.g., at block 344), and/or for other reasons.

### Example User Interfaces and Related Functionality

FIG. 4 shows an example interactive graphical user interface 400 through which the data transformation system 102 may receive one or more user inputs approving, disapproving, editing, and/or otherwise interacting with transformation rules according to various implementations of the present disclosure. In various implementations, the example user interface 400 may be presented through the user interface module 104 of the data transformation system 102 and/or a user interface of the user device 150.

As shown in FIG. 4, the user interface 400 can include a filter display 402, a transformation rule list 404, a display portion 406, a similar transformation rules list 418, an approve button 408, a disapprove button 410, an edit button 412, a delete button 414, and a new button 416. The transformation rule list 404 can display transformation rules in the data transformation system 102 (e.g., transformation rules generated using method 300). The transformation rule list 404 can include information associated with each transformation rule, such as a date the transformation rule was created and/or a confidence score associated with the transformation rule. A user may select a transformation rule from the transformation rule list 404 to be displayed in the display portion 406.

The filter display 402 may allow a user to filter the transformation rules displayed in the transformation rule list 404. For example, a user may filter the transformation rules by confidence score, by approval status, and/or otherwise filter the transformation rules. In the illustrated implementation the filter display 402 includes a graph indicating a number of transformation rules with associated confidence scores that fall within value ranges.

The display portion 406 can display a selected transformation rule. In some implementations, the display portion 406 can also display information associated with the selected transformation rule (e.g., an approval status of the transformation rule, a date the transformation rule was added, a confidence score associated with the transformation rule, etc.). A user may select the approve button 408 to approve the transformation rule shown in display portion 406, the disapprove button 410 to disapprove the transformation rule shown in display portion 406, and/or the delete button 414 to delete the transformation rule shown in display portion 406. A user may select the new button 416 to generate a new transformation rule (e.g., through method 300).

The similar transformation rules list 418 can display similar transformation rules to the transformation rule shown in display portion 406. The similarity may be determined, for example, through a semantic similarity determination. For example, the semantic similarity may be compared using LLMs (e.g., LLM 130a and/or LLM 130b). In some implementations, similarity between transformation rules is determined when the transformation rules are generated. For example, the prompt used to generate the transformation rule (e.g., the prompt generated at block 304) may include instructions on finding similar transformation rules.

FIG. 5 shows an example interactive graphical user interface 500 through which the data transformation system 102 may receive one or more user inputs approving, submitting feedback for, validating, and/or otherwise interacting with transformed data states and associated initial data states according to various implementations of the present disclosure. In various implementations, the example user interface 500 may be presented through the user interface module 104 of the data transformation system 102 and/or a user interface of the user device 150.

As shown in FIG. 5, the user interface 500 can include a segment dropdown selection 502, a translation list 504, an initial data state display portion 514, a translated data state display portion 516, an approve button 506, a submit feedback button 508, a delete translation button 510, and a run validation button 512. The segment dropdown selection 502 and/or the translation list 504 may be used to select a translation performed by the data transformation system 102. In some implementations, the segment dropdown selection 502 may be used to select data that has been transformed by the data transformation system 102 and the translation list 504 may be used to select a translation of a portion of the selected data (e.g., a particular snippet of the selected data) and/or a specific translation of the selected data (e.g., when multiple translations have been performed on the selected data). The translation list 504 may display information associated with each translation, such as a name of the transformed data state, a name of the initial data state, timestamps of when the translation was performed, indications of whether the translation was successful, and/or other information.

The initial data state display portion 514 can display the contents of an initial data state associated with a transformation selected from the translation list 504. In the illustrated example, initial data state display portion 514 displays a portion of a contract that has not been altered by the data transformation system 102. The initial data state display portion 514 can also display information (e.g., properties) associated with the initial data state, such as the initial segment name, a type of the initial data state, a target type for the transformation (e.g., a goal type for the transformed data state) and/or other information.

The translated data state display portion 516 can display the contents of a transformed data state associated with a transformation selected from the translation list 504. In the illustrated example, translated data state display portion 516 displays a portion of a contract that has been altered by the data transformation system 102. The translated data state display portion 516 can also display information (e.g., properties) associated with the initial data state, such as the translated data state name, an indication if the translation was successful, a timestamp of when the translation was performed, a named of the initial data state associated with the transformation data state, names of feedback and/or reasoning files, and/or other information.

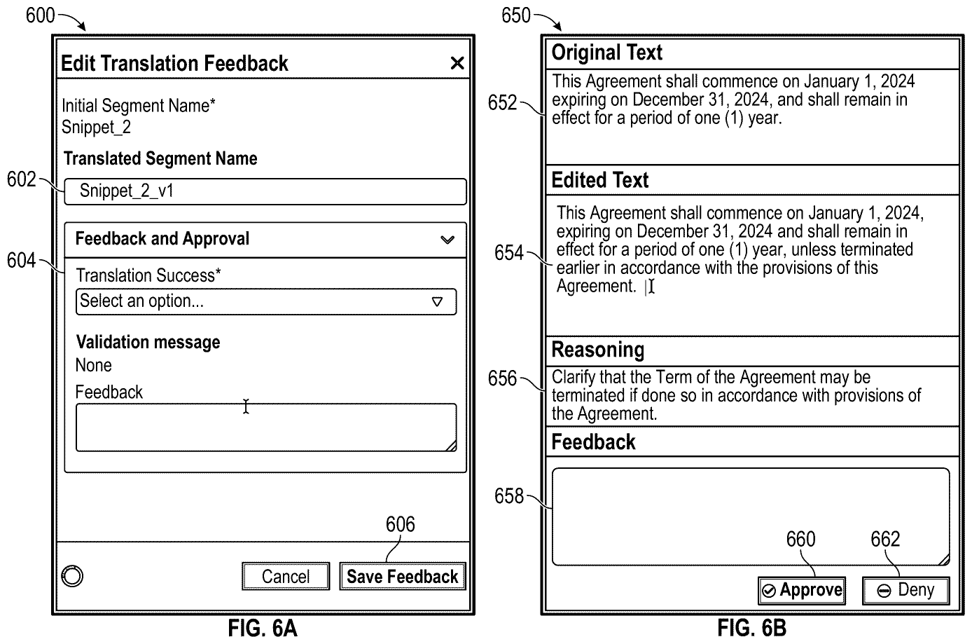

A user may approve the translation using the approve button 506. For example, a user may review the contents displayed in the translated data state display portion 516 and, if the contents is acceptable to the user, select the approve button 506 to approve the translation. The user may select the submit feedback button 508 to submit feedback on the translation. In some implementations, selecting the submit feedback button 508 may cause the data transformation system 102 to generate a different user interface, such as the user interface 600 of FIG. 6A or user interface 650 of FIG. 6B, both described below.

A user may delete the selected translation using the delete translation button 510. A user may validate the selected translation using the run validation button 512. For example, in some instances it may be beneficial to run one or more validation tests on the transformed data state. As a specific nonlimiting example, if the transformed data state is computer-executable code a validation test may be whether the computer-executable code compiles. In some implementations, the run validation button 512 may be used to determine a correctness of the transformed data state associated with the selected transformation.

FIGS. 6A and 6B show example interactive graphical user interfaces through which the data transformation system 102 may receive one or more user inputs submitting feedback for transformed data states according to various implementations of the present disclosure. FIG. 6A shows an example interactive graphical user interface 600 and FIG. 6B shows an example interactive graphical user interface 650. In some implementations, the user interface 600 and/or the user interface 650 may be generated and presented to a user after the submit feedback button 508 shown in FIG. 5 has been selected. In various implementations, the user interface 600 and/or the user interface 650 may be presented through the user interface module 104 of the data transformation system 102 and/or a user interface of the user device 150.

The user interface 600 can include a name portion 602, a feedback portion 604, and a save feedback button 606. The name portion 602 can display a name of an associated transformed data state. In some implementations, a user can edit the name of the transformed data state using the name portion 602. A user may use the feedback portion 604 to input feedback. The feedback may be used in subsequent translations of initial data states associated with the transformed data state. In some implementations, the feedback portion 604 may also allow a user to indicate whether the translation was successful. A user can select the save feedback button 606 to save the feedback entered in the feedback portion 604.

The user interface 650 can include an original text portion 652, an edited text portion 654, a reasoning portion 656, a feedback portion 658, an approve button 660, and a deny button 662. The content of an associated initial data state can be displayed in the original text portion 652. The content of an associated translated data state can be displayed in the edited text portion 654. In some implementations, a user may alter the text in the edited text portion 654 directly. Altering the texted in the edited text portion 654 may alter transformation rules associated with the transformed data sate, update confidence scores of associated transformation rules, be saved as feedback for use in subsequent translations, and/or otherwise used by the data transformation system 102. The reasoning portion 656 may display reasonings associated a transformation and/or transformation rules used in the translation. A user may use the feedback portion 604 to input feedback. The feedback may be used in subsequent translations of initial data states associated with the transformed data state.

A user can select the approve button 660 to approve the translation and save feedback and/or edits to the edited text portion 654 the user entered. A user can select the deny button 662 to deny the translation. In some implementations, selecting the deny button 662 saves feedback and/or edits to the edited text portion 654 to be used in future translations.

### Additional Example Implementations and Details

In an implementation of the system may comprise, or be implemented in, a “virtual computing environment”. As used herein, the term “virtual computing environment” should be construed broadly to include, for example, computer-readable program instructions executed by one or more processors implement one or more aspects of the modules and/or functionality described herein. Further, in this implementation, one or more services/modules/engines and/or the like of the system may be understood as comprising one or more rules engines of the virtual computing environment that, in response to inputs received by the virtual computing environment, execute rules and/or other program instructions to modify operation of the virtual computing environment. For example, a request received from a user computing device may be understood as modifying operation of the virtual computing environment to cause the request access to a resource from the system. Such functionality may comprise a modification of the operation of the virtual computing environment in response to inputs and according to various rules. Other functionality implemented by the virtual computing environment (as described throughout this disclosure) may further comprise modifications of the operation of the virtual computing environment, for example, the operation of the virtual computing environment may change depending on the information gathered by the system. Initial operation of the virtual computing environment may be understood as an establishment of the virtual computing environment. In various implementations the virtual computing environment may comprise one or more virtual machines, containers, and/or other types of emulations of computing systems or environments. In various implementations the virtual computing environment may comprise a hosted computing environment that includes a collection of physical computing resources that may be remotely accessible and may be rapidly provisioned as needed (commonly referred to as “cloud” computing environment).

Implementing one or more aspects of the system as a virtual computing environment may advantageously enable executing different aspects or modules of the system on different computing devices or processors, which may increase the scalability of the system. Implementing one or more aspects of the system as a virtual computing environment may further advantageously enable sandboxing various aspects, data, or services/modules of the system from one another, which may increase security of the system by preventing, e.g., malicious intrusion into the system from spreading. Implementing one or more aspects of the system as a virtual computing environment may further advantageously enable parallel execution of various aspects or modules of the system, which may increase the scalability of the system. Implementing one or more aspects of the system as a virtual computing environment may further advantageously enable rapid provisioning (or de-provisioning) of computing resources to the system, which may increase scalability of the system by, e.g., expanding computing resources available to the system or duplicating operation of the system on multiple computing resources. For example, the system may be used by thousands, hundreds of thousands, or even millions of users simultaneously, and many megabytes, gigabytes, or terabytes (or more) of data may be transferred or processed by the system, and scalability of the system may enable such operation in an efficient and/or uninterrupted manner.

Various implementations of the present disclosure may be a system, a method, and/or a computer program product at any possible technical detail level of integration. The computer program product may include a computer-readable storage medium (or mediums) having computer-readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer-readable storage medium (or mediums). Computer-readable storage mediums may also be referred to herein as computer-readable storage or computer-readable storage devices.

The computer-readable storage medium can be a tangible device that can retain and store data and/or instructions for use by an instruction execution device. The computer-readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions (as also referred to herein as, for example, “code,” “instructions,” “module,” “application,” “software application,” “service,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer-readable program instructions may be callable from other instructions or from itself, and/or may be invoked in response to detected events or interrupts. Computer-readable program instructions configured for execution on computing devices may be provided on a computer-readable storage medium, and/or as a digital download (and may be originally stored in a compressed or installable format that requires installation, decompression, or decryption prior to execution) that may then be stored on a computer-readable storage medium. Such computer-readable program instructions may be stored, partially or fully, on a memory device (e.g., a computer-readable storage medium) of the executing computing device, for execution by the computing device. The computer-readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various implementations, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart(s) and/or block diagram(s) block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid-state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid-state drive) either before or after execution by the computer processor.

The flowcharts and block diagrams in the Figures illustrate the architecture, functionality, and operation of possible implementations of systems, methods, and computer program products according to various implementations of the present disclosure. In this regard, each block in the flowchart or block diagrams may represent a service, module, segment, or portion of instructions, which comprises one or more executable instructions for implementing the specified logical function(s). In various alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted or optional in various implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, and/or the like with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above implementations may generally (but not necessarily) be controlled and/or coordinated by operating system software, such as Mac OS, IOS, Android, Chrome OS, Windows OS (e.g., Windows XP, Windows Vista, Windows 7, Windows 8, Windows 10, Windows 11, Windows Server, and/or the like), Windows CE, Unix, Linux, SunOS, Solaris, Blackberry OS, VxWorks, or other suitable operating systems. In other implementations, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

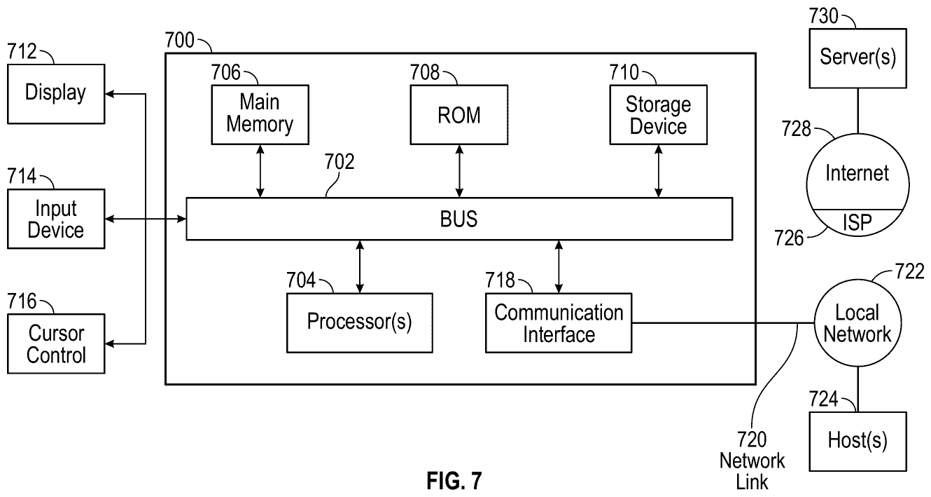

For example, FIG. 7 shows a block diagram that illustrates a computer system 700 upon which various implementations and/or aspects (e.g., one or more aspects of the computing environment 100, one or more aspects of the data transformation system 102, one or more aspects of the user device 150, one or more aspects of the LLMs 130a and 130b, and/or the like) may be implemented. Multiple such computer systems 700 may be used in various implementations of the present disclosure. Computer system 700 includes a bus 702 or other communication mechanism for communicating information, and a hardware processor, or multiple processors, 704 coupled with bus 702 for processing information. Hardware processor(s) 704 may be, for example, one or more general purpose microprocessors.

Computer system 700 also includes a main memory 706, such as a random-access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions. The main memory 706 may, for example, include instructions to implement server instances, queuing modules, memory queues, storage queues, user interfaces, and/or other aspects of functionality of the present disclosure, according to various implementations.

Computer system 700 further includes a read only memory (ROM) 708 or other static storage device coupled to bus 702 for storing static information and instructions for processor 704. A storage device 710, such as a magnetic disk, optical disk, or USB thumb drive (Flash drive), and/or the like, is provided and coupled to bus 702 for storing information and instructions.

Computer system 700 may be coupled via bus 702 to a display 712, such as a cathode ray tube (CRT) or LCD display (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. In some implementations, the same direction information and command selections as cursor control may be implemented via receiving touches on a touch screen without a cursor.

Computer system 700 may include a user interface module to implement a GUI that may be stored in a mass storage device as computer executable program instructions that are executed by the computing device(s). Computer system 700 may further, as described below, implement the techniques described herein using customized hard-wired logic, one or more ASICs or FPGAs, firmware and/or program logic which in combination with the computer system causes or programs computer system 700 to be a special-purpose machine. According to one implementation, the techniques herein are performed by computer system 700 in response to processor(s) 704 executing one or more sequences of one or more computer-readable program instructions contained in main memory 706. Such instructions may be read into main memory 706 from another storage medium, such as storage device 710. Execution of the sequences of instructions contained in main memory 706 causes processor(s) 704 to perform the process steps described herein. In alternative implementations, hard-wired circuitry may be used in place of or in combination with software instructions.

Various forms of computer-readable storage media may be involved in carrying one or more sequences of one or more computer-readable program instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN (or WAN component to communicated with a WAN). Wireless links may also be implemented. In any such implementation, communication interface 718 sends and receives electrical, electromagnetic, or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic, or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

As described above, in various implementations certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain implementations, one or more of the computing devices and/or systems of the disclosure may include mobile computing devices, and user interfaces may be accessible through such mobile computing devices (for example, smartphones and/or tablets).

Many variations and modifications may be made to the above-described implementations, the elements of which are to be understood as being among other acceptable examples. All such modifications and variations are intended to be included herein within the scope of this disclosure. The foregoing description details certain implementations. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### Example Clauses

Examples of implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1. A computer-implemented method, performed by a computing system having one or more hardware computer processors and one or more computer-readable storage devices storing software instructions executable by the computing system, the computer-implemented method comprising: receiving or accessing one or more data transformations, wherein the one or more data transformations include initial data states and respective corresponding transformed data states; generating a first artificial intelligence (“AI”) model prompt, the first AI model prompt including the one or more data transformations and rule generation instructions, wherein the rule generation instructions include instructions to generate one or more transformation rules based on comparisons between the initial data states and respective corresponding transformed data states of the one or more data transformations; providing the first AI model prompt to a first AI model; receiving a first output from the first AI model in response to the first AI model prompt; determining and/or parsing the first output from the first AI model to determine the one or more transformation rules; receiving or accessing a first initial data state to be transformed; generating a second AI model prompt, the second AI model prompt including the one or more transformation rules and data transformation instructions, wherein the data transformation instructions include instructions to generate a first transformed data state by applying at least one of the one or more transformation rules to the first initial data state; providing the second AI model prompt to a second AI model; receiving a second output from the second AI model in response to the second AI model prompt; and determining the first transformed data state from the second output.

Clause 2. The computer-implemented method of claim 1, wherein the first AI model and/or the second AI model comprise at least one of: language models, or large language models (“LLM”).

Clause 3. The computer-implemented method of any of claims 1-2, wherein the first AI model and the second AI model are at least one of: different AI models, or a same AI model.

Clause 4. The computer-implemented method of any of claims 1-3, wherein the rule generation instructions further include instructions to avoid generating duplicate or similar transformation rules.

Clause 5. The computer-implemented method of any of claims 1-4, wherein the rule generation instructions further include instructions to indicate, for each transformation rule of the one or more transformation rules, whether the transformation rule is a contradiction to another of the one or more transformation rules.

Clause 6. The computer-implemented method of any of claims 1-5, wherein the rule generation instructions further include instructions to output the one or more transformation rules in a computer parseable format.

Clause 7. The computer-implemented method of any of claims 1-6 further comprising: receiving one or more user inputs approving or rejecting transformation rules of the one or more transformation rules, wherein any rejected transformation rules are removed from the one or more transformation rules such that the second AI model prompt does not include such rejected transformation rules.

Clause 8. The computer-implemented method of any of claims 1-7 further comprising: generating data usable to generate, and/or causing display of, an interactive graphical user interface including: a listing of the one or more transformation rules, and interactive user interface elements usable for a user to approve or reject transformation rules.

Clause 9. The computer-implemented method of claim 8, wherein the interactive graphical user interface further includes: for a selected transformation rule of the one or more transformation rules, indications of any other transformation rules of the transformation rules that are similar to the selected transformation rule.

Clause 10. The computer-implemented method of any of claims 1-9, wherein the data transformation instructions further include feedback from a previous translation of the first initial data state and instructions to take into account the feedback in generating the first transformed data state.

Clause 11. The computer-implemented method of claim 1, wherein the second AI model prompt further includes one or more example data transformations that are similar to the first initial data state.

Clause 12. The computer-implemented method of any of claims 1-11, wherein the rule generation instructions further include instructions to indicate, for each of the transformation rules of the one or more transformation rules, respective associated confidence scores.

Clause 13. The computer-implemented method of claim 12, wherein the data transformation instructions further include instructions to prioritize the one or more transformation rules based on the respective associated confidence scores.

Clause 14. The computer-implemented method of any of claims 12-13 further comprising: receiving one or more user inputs approving, rejecting, modifying, and/or providing feedback regarding, the first transformed data state; and in response to and/or based on the one or more user inputs, modifying a confidence score associated with a transformation rule, of the one or more transformation rules, that was used to generate the first transformed data state.

Clause 15. The computer-implemented method of claim 14, wherein the one or more user inputs are used as feedback in a subsequent translation of the first initial data state.

Clause 16. The computer-implemented method of any of claims 12-15 further comprising: determining a correctness of the first transformed data state; and based on the correctness determination at least one of: modifying a confidence score associated with a transformation rule, of the one or more transformation rules, that was used to generate the first transformed data state; or generating a feedback to be used in a subsequent translation of the first initial data state.

Clause 17. The computer-implemented method of claim 16, wherein determining the correctness of the first transformed data state includes at least one of: parsing the first transformed data state, validating the first transformed data state, or executing the first transformed data state.

Clause 18. The computer-implemented method of any of claims 1-17 further comprising: generating data usable to generate, and/or causing display of, an interactive graphical user interface including: an indication of the first initial data state; an indication of the first transformed data state; and interactive user interface elements usable for a user to approve, reject, modify, and/or provide feedback regarding, the first transformed data state.

Clause 19. A system comprising: one or more computer-readable storage mediums or devices comprising, configured to store, and/or storing program instructions; and one or more processors configured to execute the program instructions to cause the system to perform the computer-implemented method of any of claims 1-18.

Clause 20. One or more computer-readable storage mediums or devices comprising, configured to store, and/or storing program instructions, the program instructions executable by one or more processors to cause the one or more processors to perform the computer-implemented method of any of claims 1-18.

What is claimed is:

1. A computer-implemented method, performed by a computing system having one or more hardware computer processors and one or more computer-readable storage devices storing software instructions executable by the computing system, the computer-implemented method comprising:
receiving or accessing one or more data transformations, wherein the one or more data transformations include initial data states and respective corresponding transformed data states;
generating a first artificial intelligence (“AI”) model prompt, the first AI model prompt including the one or more data transformations and rule generation instructions, wherein the rule generation instructions include instructions to generate one or more transformation rules based on comparisons between the initial data states and respective corresponding transformed data states of the one or more data transformations;
providing the first AI model prompt to a first AI model;
receiving a first output from the first AI model in response to the first AI model prompt;
determining and/or parsing the first output from the first AI model to determine the one or more transformation rules;
receiving or accessing a first initial data state to be transformed;
generating a second AI model prompt, the second AI model prompt including the one or more transformation rules and data transformation instructions, wherein the data transformation instructions include instructions to generate a first transformed data state by applying at least one of the one or more transformation rules to the first initial data state;
providing the second AI model prompt to a second AI model;
receiving a second output from the second AI model in response to the second AI model prompt; and
determining the first transformed data state from the second output.

2. The computer-implemented method of claim 1, wherein the first AI model and/or the second AI model comprise at least one of: language models, or large language models (“LLM”).

3. The computer-implemented method of claim 1, wherein the first AI model and the second AI model are at least one of: different AI models, or a same AI model.

4. The computer-implemented method of claim 1, wherein the rule generation instructions further include instructions to avoid generating duplicate or similar transformation rules.

5. The computer-implemented method of claim 1, wherein the rule generation instructions further include instructions to indicate, for each transformation rule of the one or more transformation rules, whether the transformation rule is a contradiction to another of the one or more transformation rules.

6. The computer-implemented method of claim 1, wherein the rule generation instructions further include instructions to output the one or more transformation rules in a computer parseable format.

7. The computer-implemented method of claim 1, further comprising:
receiving one or more user inputs approving or rejecting transformation rules of the one or more transformation rules, wherein any rejected transformation rules are removed from the one or more transformation rules such that the second AI model prompt does not include such rejected transformation rules.

8. The computer-implemented method of claim 1, further comprising:
generating data usable to generate, and/or causing display of, an interactive graphical user interface including: a listing of the one or more transformation rules, and interactive user interface elements usable for a user to approve or reject transformation rules.

9. The computer-implemented method of claim 8, wherein the interactive graphical user interface further includes: for a selected transformation rule of the one or more transformation rules, indications of any other transformation rules of the transformation rules that are similar to the selected transformation rule.

10. The computer-implemented method of claim 1, wherein the data transformation instructions further include feedback from a previous translation of the first initial data state and instructions to take into account the feedback in generating the first transformed data state.

11. The computer-implemented method of claim 1, wherein the second AI model prompt further includes one or more example data transformations that are similar to the first initial data state.

12. The computer-implemented method of claim 1, wherein the rule generation instructions further include instructions to indicate, for each of the transformation rules of the one or more transformation rules, respective associated confidence scores.

13. The computer-implemented method of claim 12, wherein the data transformation instructions further include instructions to prioritize the one or more transformation rules based on the respective associated confidence scores.

14. The computer-implemented method of claim 12, further comprising:
receiving one or more user inputs approving, rejecting, modifying, and/or providing feedback regarding, the first transformed data state; and
in response to and/or based on the one or more user inputs, modifying a confidence score associated with a transformation rule, of the one or more transformation rules, that was used to generate the first transformed data state.

15. The computer-implemented method of claim 14, wherein the one or more user inputs are used as feedback in a subsequent translation of the first initial data state.

16. The computer-implemented method of claim 12 further comprising:
determining a correctness of the first transformed data state; and
based on the correctness determination at least one of:
modifying a confidence score associated with a transformation rule, of the one or more transformation rules, that was used to generate the first transformed data state; or
generating a feedback to be used in a subsequent translation of the first initial data state.

17. The computer-implemented method of claim 16, wherein determining the correctness of the first transformed data state includes at least one of: parsing the first transformed data state, validating the first transformed data state, or executing the first transformed data state.

18. The computer-implemented method of claim 1, further comprising:
generating data usable to generate, and/or causing display of, an interactive graphical user interface including:
an indication of the first initial data state;
an indication of the first transformed data state; and
interactive user interface elements usable for a user to approve, reject, modify, and/or provide feedback regarding, the first transformed data state.

19. A system comprising:
one or more computer-readable storage mediums or devices comprising, configured to store, and/or storing program instructions; and
one or more processors configured to execute the program instructions to cause the system to perform the computer-implemented method of claim 1.

20. One or more computer-readable storage mediums or devices comprising, configured to store, and/or storing program instructions, the program instructions executable by one or more processors to cause the one or more processors to perform the computer-implemented method of claim 1.
